(19) United States
(12) Patent Application Publication
(10) Pub. No.: US 2020/0184766 A1
(43) Pub. Date: Jun. 11, 2020

(54) GAMING SYSTEM AND METHOD HAVING NON-INTERACTING

(71) Applicant: ADP GAUSELMANN GMBH, Espelkamp (DE)

(72) Inventors: Michael Charles Halvorson, Las Vegas, NV (US); Josef Alexander Hartl, Las Vegas, NV (US); Charles Hiten, Lighthouse, FL (US)

(21) Appl. No.: 16/792,108

(22) Filed: Feb. 14, 2020

Related U.S. Application Data
(63) Continuation-in-part of application No. 16/120,515, filed on Sep. 4, 2018, now Pat. No. 10,573,121.
Application No. 16/120,515 is a continuation of application No. 15/721,808, filed on Sep. 30, 2017, now Pat. No. 10,089,819.

(51) Int. Cl. G07F 17/32; G07F 17/34

(52) U.S. Cl. CPC G07F 17/3213; G07F 17/3267; G07F 17/34; G07F 17/3209; G07F 17/3288; G07F 17/3244

(57) ABSTRACT

A gaming system and method may include one or more non-interacting reels that can be used in a hold and respin feature or bonus game. In some implementations, the interacting symbols of the non-interacting reel can interact with symbols on associated reels to determine player awards.

### CROSS-REFERENCE TO RELATED APPLICATIONS

This application is a continuation-in-part of U.S. application Ser. No. 16/120,515 filed Sep. 4, 2018, which is a continuation of U.S. application Ser. No. 15/721,808 filed Sep. 30, 2017, now U.S. Pat. No. 10,089,819, each of which is incorporated herein by reference in its entirety.

### FIELD OF THE INVENTION

The present disclosure relates to gaming devices.

### SUMMARY OF THE INVENTION

The present disclosure is directed to systems and processes for gaming. In various implementations the gaming system provides a hold and respin game that may include one or more rounds. In some implementations, the gaming system and process may include one or more non-interacting reels that can be used in a hold and respin feature or bonus game. In some implementations, the interacting symbols of the non-interacting reel can interact with symbols on associated reels to determine player awards.

In some implementations the gaming system includes a display device, an input device, a value acceptor, a value dispenser, a random number generator, a memory device, and a processor, where the memory device stores program instructions that, when executed by the processor, cause the processor to: establish a credit balance based on a value received by the value acceptor; receive, via the input device, a wager for a play of a game using the credit balance; determine, using the random number generator, a first plurality of symbols from a set of reels; determine, using the random number generator, a second plurality of symbols from a non-interacting reel, where the second plurality of symbols may include at least one interacting symbol; display, on the display device, the first plurality of symbols in a plurality of symbol display areas of the set of reels; display, on the display device, the second plurality of symbols in a second plurality of symbol display areas of the non-interacting reel, where the second plurality of symbol display areas are different from the first plurality of symbol display areas; assign an award to at least one of the first plurality of symbols based on the at least one interacting symbol of the second plurality of symbols; issue the award assigned to the at least one of the first plurality of symbols; and issue a second value from the value dispenser based on the award.

In some implementations of a method of operating a gaming system, the method of operating the gaming system includes establishing, by a processor, a credit balance based on a value received by the value acceptor. The method of operating the gaming system may include receiving, by the processor from a player input device, a wager for a play of a game using the credit balance. The method of operating the gaming system may include determining, using a random number generator, a first plurality of symbols from a set of reels. The method of operating the gaming system may include determining, using the random number generator, a second plurality of symbols from a non-interacting reel, where the second plurality of symbols may include at least one interacting symbol. The method of operating the gaming system may include displaying, on a display device, the first plurality of symbols in a plurality of symbol display areas of the set of reels. The method of operating the gaming system may include displaying, on the display device, the second plurality of symbols in a second plurality of symbol display areas of the non-interacting reel, where the second plurality of symbol display areas are different from the first plurality of symbol display areas. The method of operating the gaming system may include assigning, using the processor, an award to at least one of the first plurality of symbols based on the at least one interacting symbol of the second plurality of symbols. The method of operating the gaming system may include issuing, using the processor, the award assigned to the at least one of the first plurality of symbols. The method of operating the gaming system may include issuing a second value from the value dispenser based on the award.

### BRIEF DESCRIPTION OF THE DRAWINGS

FIG. 1 is a perspective view of an implementation of a stand-alone gaming device.

FIG. 2 is a functional block diagram of the gaming device technology components.

FIGS. 3A and 3B illustrate one implementation of a method of operating the gaming system.

FIGS. 4A, 4B, 4C, and 4D illustrate screen shots of an example implementation of a gaming system having a non-interacting reel and an interacting symbol.

FIGS. 5A, 5B, 5C, and 5D illustrate screen shots of another example implementation of a gaming system having a non-interacting reel and a plurality of interacting symbols.

FIG. 6 illustrates screen shots of another example implementation of a gaming system having a plurality of non-interacting reels.

FIG. 7 illustrates screen shots of another example implementation of a gaming system having a plurality of non-interacting reels.

FIG. 8 illustrates screen shots of another example implementation of a gaming system having a plurality of non-interacting reels.

FIG. 9 illustrates one implementation of a method of operating the gaming system

FIG. 10A-10D illustrates screen shots of another example implementation of a gaming system having a non-interacting reel.

### DETAILED DESCRIPTION OF THE INVENTION

In various implementations, a gaming system and method display a plurality of columns of symbols and at least one separate row of symbols. In one implementation, the gaming system may evaluate the symbols displayed in the plurality of columns for winning symbol combinations without evaluating symbols displayed in the at least one separate row of symbols to determine if any winning symbol combinations are displayed. In other words, the at least one separate row of symbols is a non-interacting row. In some implementations, the plurality of columns of symbols are formed for a first set of gaming reels that is oriented a first way and the at least one separate row of symbols is formed for a non-interacting reel that is oriented differently with respect to the first set of gaming reels.

In one implementation, the gaming system and method may receive a monetary value through a value acceptor. The gaming system may establish a credit balance based at least in part on the received monetary value. The gaming system may receive a wager from an input device and decrease the credit balance in accordance with the amount of the wager. The gaming system may display on a display device, a plurality of symbol display areas including a first symbol display area and a second symbol display area. The gaming system may display on the display device, a first plurality of randomly determined symbols from a first set of a plurality of symbols in the first symbol display area, wherein the first plurality of randomly determined symbols are displayed in a plurality of columns. The gaming system may further display on the display device, a second plurality of randomly determined symbols from a second set of symbols in the second symbol display area, wherein the second plurality of randomly determined symbols are displayed in at least one row.

The gaming system may, with a processor, associate each of the second plurality of randomly determined symbols with one column of the plurality of columns. In one implementation, the second plurality of randomly determined symbols further comprises at least one interacting symbol. The gaming system may determine, with the processor, if any interacting symbols are generated for display in the second plurality of randomly determined symbols. If the gaming system determines, with the processor, that an interacting symbol is displayed, the gaming system may identify a column of the plurality of columns that is associated with the displayed interacting symbol. The gaming system may determine, with the processor, if any of the displayed first plurality of randomly determined symbols in the identified column is a predetermined symbol that interacts with the displayed interacting symbol. If the gaming system determines that a predetermined symbol is displayed in the identified column, the gaming system may execute, with the processor, a game function based on the predetermined symbol and the interacting symbol. In one implementation, the gaming function may include altering at least one of the displayed first plurality of randomly determined symbols, starting or initiating a bonus game, or other suitable gaming functions. In some implementations, two or more gaming functions can be executed. The gaming system may determine, with the processor, any awards based on the symbols displayed in the first symbol display area and the received wager. The gaming system may display, on the display device, any determined awards and increase the credit balance by any determined awards. Upon receipt of a cash out signal via the input device, the gaming system may issue a value based on the credit balance from a value dispenser of the gaming device.

### Gaming Device Platform

The features and advantages of the systems and methods described herein may be provided to a player via a gaming system that includes various structures and components for allowing player interaction with the gaming system. While some examples of gaming systems are described in detail herein, it is understood that the features, objects, and advantages of such gaming systems may be implemented in one or more alternative implementations consistent with the present disclosure.

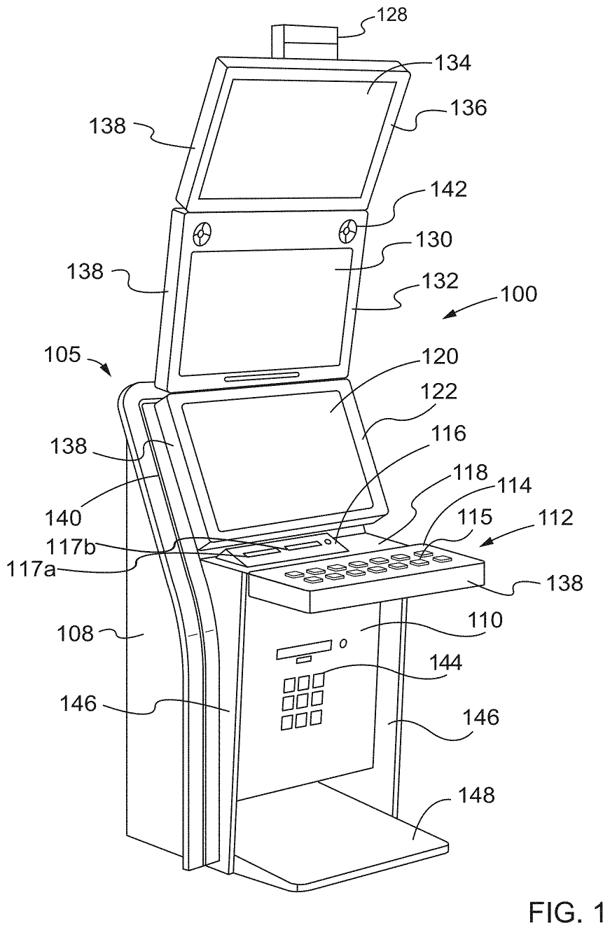

FIG. 1 shows a perspective view illustrating an example of gaming system 100 in accordance with aspects of the present disclosure. The gaming system 100 may be referred to as a slot machine and, as illustrated, includes a cabinet 105 (e.g., a housing) constructed so that a player can operate and play the gaming system 100 while standing or sitting. The cabinet 105 can include a pair of cabinet side panels 108 (one of which is visible in the perspective view of FIG. 1 and another that is partially visible in FIG. 1), a front panel 110, and a rear panel (not shown). Additionally, a base panel (not shown) and a top panel surface (not shown) may support a first game display device 120 and the player interaction area 112. The cabinet panels 108, 110 (as well as the base panel and the top panel surface) may be interconnected to form the cabinet 105, which encloses and houses components of the gaming system 100. The cabinet 105 may function to securely protect a local game controller and technology components, and to provide support for game display(s) and player input and output systems of the gaming system 100, such as described herein below.

While the example cabinet 105 is depicted as having a particular shape, structure, and organization, it should be appreciated that a wide variety of cabinet enclosure sizes, shapes, and designs are possible for the gaming system 100. For example, the cabinet panels 108, 110 (as well as the base panel and the top panel surface) may be combined into fewer elements or divided into additional elements. Additionally, the positions of the displays (e.g., first display device 120) and input and output devices can be rearranged with respect to one another. In some implementations, the gaming system 100 may include more or fewer components than described herein.

A player can interact with the gaming system 100 in various ways to direct wagering and game activities. The cabinet 105 may include player input systems and output systems generally designated as the player interaction area 112. In some implementations, the player interaction area 112 can be located on the front top side of cabinet 105 and, as shown, on a panel structure that extends outwardly from the gaming system 100 in a player's direction. The player interaction area 112 may contain player input and output systems, including a player control area 114 with one or more input devices 115, a player value acceptor and dispenser area 116, and player convenience input area 118. It should be appreciated that the player interaction area 112 can be placed in other suitable areas of the gaming system 100. In some implementations, the player input and output systems of player interaction area 112 can be positioned in areas apart from each other within interaction area 112. In some implementations, the player input and output systems can be positioned apart from each other such that the player input and output systems are not all contained in player interaction area 112.

In some implementations, the player control area 114 may include the input devices 115, such as buttons and touch sensitive areas, through with which players may interact with the gaming system 100 to direct game activities. The cabinet 105 can provide an easily accessible location and support for player input and output interactions with the gaming system 100, including gaming control interactions and value wagering interactions. Although the gaming system 100 illustrated in FIG. 1 shows the input devices 115 of the player control area 114 as physical controls (e.g., buttons), it is understood that in some implementations, a player's gaming control inputs could be made using physical controls (e.g., hardware buttons, levers, etc.), “soft” controls (e.g., software driven buttons) located on a gaming display and activated by player touch (e.g., touch screen interfaces), motion detection interfaces, etc. It should be appreciated that a player's gaming control inputs can be made using a suitable combination of input devices.

In some implementations, when a player depresses or selects one of the input devices 115, that input device 115 may cause requests, messages, and/or signals to be sent to one or more processors of the gaming system 100. The input devices 115 may be associated with, but are not limited to the following game controls: game selection button(s) (e.g., where more than one game is provided in a single gaming system 100); gaming denomination value selection button(s); wager selection button(s) for the player to indicate or select the desired wager value for a game; pay line selection button(s) for selecting the number of active pay lines in game implementations that provide multiple pay line wagering; reel spin button(s) for players to initiate one or more reels to spin in a game; a repeat last bet button for players to conveniently repeat the last game's preference and wager selections in a new game; a cash-out button for player extraction of available player credits; an attendant call button; and gaming information buttons such as show pay tables, show game rules, or show other game-related information. It should be appreciated that input devices 115 may include other suitable game control inputs.

The player value acceptor and dispenser area 116 may include one or more value acceptance devices 117a and value distribution devices 117b that allow the player to interact with the gaming system 100. The value acceptance devices 117a allow the player to input value (e.g., money, currency, paper ticket or voucher, etc.) to risk or otherwise place a wager (e.g., a monetary value) on one or more outcomes of a game. The value distribution devices 117b may return winnings to the player via some form of value distribution (e.g., currency, paper ticket or vouchers, credit on a player tracking card, credit stored in a central database, etc.). In some implementations, the value acceptance devices 117a may accept any one or more of the following from a player to establish a gaming credit balance: coins, bills, tokens, tickets/vouchers, player ID cards, credit cards, or other suitable forms of value. Thus, if the gaming system 100 accepts coins and bill, the value acceptance devices 117a may comprise a currency bill validator and a coin validator, and the value distribution devices 117b may comprise a currency bill dispenser and a coin dispenser, respectively. Likewise, if the gaming system 100 accepts paper tickets, the value acceptance devices 117a and the value distribution devices 117b may comprise a ticket acceptor that receives tickets or vouchers representing some monetary value, and a ticket printer, respectively. In some implementations, the ticket acceptor may include a bar code reader, or other appropriate code reader, for reading the encoded value contained by the player's ticket or voucher, and the ticket printer may contain a bar code printer or other appropriate code printer, for printing an encoded value onto a ticket or voucher to be dispensed. In some implementations, the value acceptance devices 117a and the value distribution devices 117b can accept and distribute more than one type of value. In some implementations, the player value acceptor and dispenser area 116 may include multiple different value acceptance devices 117a and multiple different value distribution devices 117b that accept different types of value from players and distribute different types of value to players.

In some implementations, upon receipt of some suitable type of value from the player, the value acceptance devices 117a can perform validation on the player supplied value using appropriate hardware readers (e.g., determining that the currency bills/coins/tokens/ticket/voucher/card are genuine). If the validation result is positive on player supplied value, the value acceptance devices 117a can generate a message/signal to a processor of the gaming system 100 that establishes a gaming credit balance for playing one or more games on gaming system 100.

In some implementations, the value distribution devices 117b dispenses a monetary value, or a representation thereof, from the gaming system 100 when a player chooses to “cash out” the gaming credit balance (e.g., remove value from the gaming system 100). The player may select an input device 115 associated with a cash out function. The input device 115 may cause a request/message/signal to be sent to a processor of the gaming system 100 to perform a cash out process. The player can cash out at any suitable time. When a player cashes out the value contained on a credit meter (not shown) of gaming system 100, a processor of gaming system 100 may cause a printer included in the value acceptance devices and the value distribution devices 117b to print and dispense a coded ticket or voucher through a dispensing slot to the player. The coded ticket or voucher may be a bar-coded ticket or any other suitable code (PDF517 coding or quick response (QR) coding). This ticket can then be used as value input at another gaming system, or converted to currency at a conveniently located kiosk or cashier counter located near the gaming system. Alternatively, the processor of gaming system 100 may cause a currency bill dispenser or a coin dispenser included in the value acceptance and value distribution devices 117b to dispense the value contained on the credit meter of gaming system 100.

Various combinations of the above value acceptance and value distribution arrangements are possible. The gaming system 100 may include other value acceptance and value distribution mechanisms in the player value acceptor and dispenser area 116. For example, the value acceptance devices 117a and the value distribution devices 117b may include a magnetic strip or chip card reader/writer in order to accept value from and transfer value to a magnetic strip or an embedded chip card. In other implementations, the value acceptance devices 117a and value distribution devices 117b may include hardware for transferring (and receiving) non-traditional currencies to players such as digital currencies (e.g., bitcoin). In some implementations, the gaming system 100 may update a record of the player's credit meter balance to a remote database.

In some implementations, the value acceptance devices 117a and value distribution devices 117b may include a card reader that accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system 100 may be associated with the player account. Additionally, gaming system 100 may include a numeric or alphanumeric keypad (not shown) that enables player entry of a personal identification number or the like for secure access to card information.

In some implementations, a player convenience input area 118 may be included in the gaming system 100, as is shown in FIG. 1. In various implementations, player convenience input area 118 may have a variety of features and functions depending on the jurisdictional deployment of the gaming system 100. In some implementations, the player convenience input area 118 may house a magnetic strip card reader (not illustrated), integrated circuit chip card reader (not illustrated), or both, for reading cards associated with a player loyalty program. In some implementations, the player convenience input area 118 may include one or more value acceptance devices 117a and one or more value distribution devices 117b. Player loyalty programs, also referred to as player tracking systems, provide magnetic strip or chip cards to players for insertion into the gaming system 100 during play. These player loyalty/players tracking cards may be associated with a player account and are utilized by the card-issuing entity to monitor, or track a player's gaming activity and build loyalty through player rewards of a variety of types. The player convenience input area 118 may include an input mechanism such as input buttons (not shown) so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. The gaming system 100 may include one or more power charging ports (e.g., universal serial bus (USB) ports, etc.) that enables a player to charge their electronics or connect to services such as the Internet or food service. Further, player convenience input area 118 of the gaming system 100 may include buttons to request food or drink service if the gaming system is located in an establishment that has food and drink service. The gaming system 100 may be connected to a local or wide area network such that selection of the requested food or drink service may alert the establishment's hospitality staff to deliver the requested service directly to the gaming system 100.

The layout of the player control area 114, player value acceptor and dispenser area 116, and the player convenience input area 118 in gaming system 100 may be arranged differently than those disclosed and illustrated herein. The selections and arrangement of player device input locations and player device output locations on the cabinet 105 may be dependent upon the game buttons, the type of value wagered, and the player conveniences utilized in the deployment configuration of gaming system 100.

In some implementations, cabinet 105 includes the first game display device 120, which can be mounted atop or flush with a top panel surface of cabinet 105. The first game display device 120 can be, for example, a 27-inch liquid crystal display (LCD) display mounted in a widescreen orientation. However, any suitable display may be connected to gaming system 100 and placed in any suitable orientation. In the illustrated implementation, the first game display device 120 can be mounted within and framed by first display frame 122 which is, in turn, mounted upon lower cabinet body portion's top panel surface. In this manner, the first game display device 120 is both surrounded and secured within the first display frame 122 and raised above the cabinet's top panel surface. Additional features of the first display frame 122 are described below. Although not illustrated, it is understood that some implementations of the gaming system 100 may use a single first game display device 120 and not include additional game displays. For example, a single first game display device 120 may span the one or more portions of the cabinet 105 and extend upwardly away from cabinet 105 in place of additional display devices (e.g., display devices 130 and 134, described below).

In some implementations, cabinet 105 can support additional display devices. In some implementations, cabinet 105 may include an upwardly extending support structure (not illustrated) that extends upwardly from the rear side of cabinet 105 and configured to mechanically support one or more additional game display devices (e.g., display devices 130 and 134, described below).

Gaming system 100 may include a cabinet top light 128. In some implementations, the cabinet top light 128 is capable of illumination in a variety of colors and can be utilized to indicate and communicate conditions of the gaming system 100 to gaming players and service personnel.

In some implementations, the upwardly extending cabinet support structure (not shown) of cabinet 105 may conceal power and communication lines between (1) the control systems and components located within cabinet 105, (2) the displays mounted on the upwardly extending support structure, and (3) cabinet top light 128.

In some implementations, as illustrated in FIG. 1, gaming system 100 may include one or more additional display devices, such as a second game display device 130 and/or a third game display device 134. The second game display device 130 and the third game display device 134 can be disposed generally in a vertical relationship and generally in alignment with the first game display device 120. Like the first game display device 120, the second game display device 130 and the third game display device 134 can be LCD display device or other suitable display devices and can be mounted in any suitable orientation in some implementations. Further, like the first game display device 120, the second game display device 130 and/or the third game display device 134 can be mounted within and framed by second display frame 132 and third display frame 136, respectively. The second display frame 132 and the third display frame 136 can be attached to the upper cabinet support structure and can protect the second game display device 130 and the third game display device 134. In some implementations, one or more of the game display devices 120, 130, and 134 may not include a display frame. In some implementations, one or more of the game display devices 120, 130, and 134 can be housed within a same display frame.

In some implementations, the first game display device 120, the second game display device 130, and the third game display device 134 can be disposed at an angle from each other to form a player-facing concave arc. However, in some implementations, the angles between the game display devices 120, 130, and 134 may be adjustable and may be smaller or greater than the angles illustrated in FIG. 1. Further, it is understood that in some implementations the displays may be disposed in a common plane relative to each other.

It also should be appreciated that in various implementations a variety of display technologies may be utilized equivalently and interchangeably with a variety of implementations of the gaming system. Equivalent display devices may include, but are not limited to, variations of liquid crystal displays, light emitting diode displays, quantum dot light emitting diode (QLED) displays, electroluminescence (EL) displays, and plasma displays.

In some implementations, different sized display devices may be combined to display gaming data on gaming system 100. As a non-limiting example, a 27-inch widescreen LCD display may be combined with a 20-inch portrait-oriented LCD or a light emitting diode (LED) display. The display devices could include organic light emitting diode displays (OLED) or other suitable display devices. This combination may be used, for example, with a third scrolling banner LED display. In alternative implementations, one, two, three, or more displays could be used in a variety of positions and orientations. Any suitable combination may be used. It should also be appreciated that a processor of gaming system 100 may communicate with the disclosed first game display device 120, second game display device 130, and third game display device 134 through a video card of gaming system 100 to produce the visible aspects of a game.

In some implementations, one or more of the first game display device 120, the second game display device 130, and the third game display device 134 may be fitted with a transparent touch sensitive overlay for sensing player touch inputs into the gaming system 100. The touch sensitive overlays can communicate with a processor of gaming system 100 to enable the player to interact with a game available on gaming system 100.

In some implementations, curved displays may be used for one or more of the display devices on gaming system 100. Similarly, any of the displays used for gaming system 100 can be based on flexible display technologies. For example, it is possible to utilize flexible display technologies to create uniquely shaped curving, wavy, or tubular display structures to provide one or more of the display devices of gaming system 100. Additionally, in some implementations flexible display technologies can be used in combination with fixed flat screen technologies.

While the gaming system 100 has been described as implemented with video technologies, in some implementations, mechanical game reels with reel strips containing game indicia and step motor controllers may be employed to provide game information to a player. In some implementations, the reel strips may include printed symbols. In another implementation, the mechanical game reels may include flexible video display technology as the reel strips on mechanical game reels. Thus, games implemented in video form can readily be implemented with mechanical game reels utilizing such display technology. Alternatively, in other implementations mechanical game reels with reels strips having fixed symbols displayed along the reel strip could be used to implement the game.

Dependent upon a housing style used in some implementations of the gaming system 100, a variety of other display technologies may be utilized in combination with the gaming system disclosed herein. For example, the gaming system 100 may have one or more display devices in addition to the main game display devices(s) in some implementations. For example, the gaming system 100 may include a player tracking device having a player tracking display which displays various information to the player regarding the player's status. The gaming system 100 may also include other game-related displays such as the wager display and the gaming credit balance meter display. These additional game-related displays may be separate display devices or may be displayed on any one or more of the first game display device 120, the second game display device 130, or the third game display device 134.

The gaming system 100 may also include cabinet lighting that can be used to, among other functions, attract players. In the example gaming system 100 illustrated in FIG. 1, attractive cabinet lighting is provided by frame accent lighting 138. The frame accent lighting 138 can be placed around any number of structures of gaming system 100. For example, the frame accent lighting 138 can be placed around the first display frame 122, the second display frame 132, the third display frame 136, and/or player interaction area 112.

The frame accent lighting 138 may include multiple components. In some implementations, the side edge pieces of the first display frame 122, the second display frame 132, the third display frame 136, and the edge structure of player interaction area 112 can be made of a translucent or transparent plastic or other suitable materials. Linear arrays, or strips, of light emitting diodes (LEDs) (not shown) on circuit boards may be mounted below or on the surface of the side edge pieces. In some implementations, the circuit boards are flexible circuit boards. These LED strips and transparent or translucent coverings may surround one or more gaming system displays frames, as well as the player interaction area, to highlight these areas. It should be appreciated that other suitable types of lighting (e.g., electroluminescence lighting) may be utilized for frame accent lighting 138.

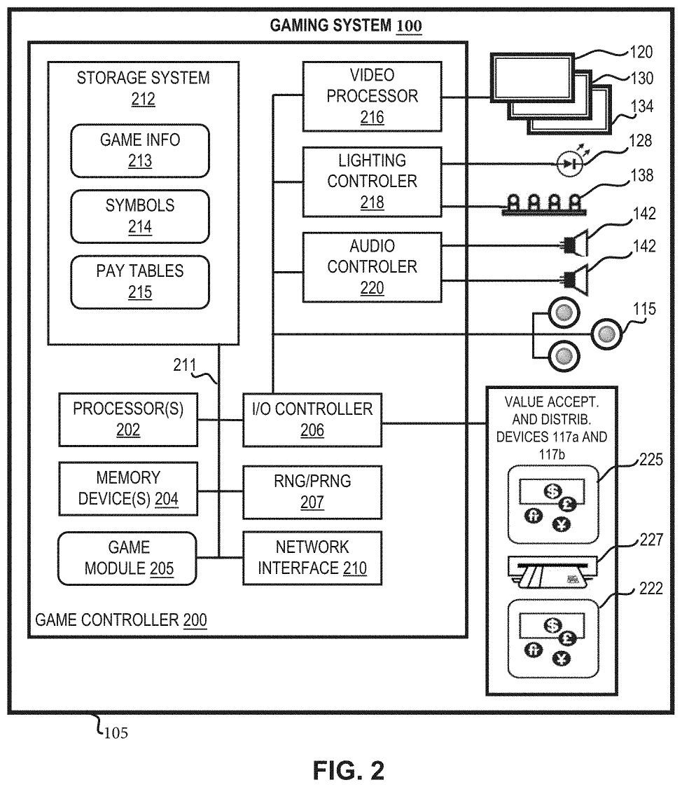

In some implementations, the individual LEDs mounted on the LED strips are of a type that can emit red, green, and blue light. In an alternative implementation, separate LEDs are used for the light colors. In some implementations, the LEDs or LED strips can be electrically connected and can be controlled by a cabinet lighting controller (e.g., cabinet lighting controller 218 in FIG. 2) in conjunction with a processor of the gaming system 100 to selectively mix the emitted light colors in a manner to create any color. The cabinet lighting controller can flash and vary lighting as desired. For example, cabinet edge lighting can change and flash in combination with music rhythms or in combination with game events. Other suitable variations are possible.

In some implementations, the cabinet 105 may include LED strip lighting or LED rope lighting to accentuate the cabinet and enhance the attractiveness of the gaming system 100 to players. LED rope lighting is a number of small light-emitting diode bulbs linked together and encased in a plastic, polyvinylchloride, or other suitable material to create a string of lights. For example, in one implementation illustrated in FIG. 1, the cabinet 105 includes cabinet accent lighting 140. In some implementations, the cabinet accent lighting 140 is LED rope lighting mounted flush with the front side edge of the cabinet side panels 108. The LED rope lighting can generate any of suitable colors, and are controlled by cabinet lighting controller and a processor of the gaming system 100 to selectively mix the emitted light colors in a manner to create any color in the same manner as the frame edge lighting.

In various implementations, the gaming system 100 includes one or more audio speakers 142 and appropriate driving electronics and sound cards so that game players may experience pleasing audio aspects of the gaming system 100. Audio is desirable to attract and maintain player interest in the gaming system 100. The gaming system 100 may also emit attraction sounds during any idle period of the gaming system 100. Game audio may add to the player's enjoyment of the gaming system 100 by providing music and sound effects designed to enhance and compliment the gaming experience. In FIG. 1, the audio speakers 142 are shown mounted on the upper corners of the second display frame 132. Any suitable number of additional audio speakers 142 may be provided on additional display frames or on cabinet 105 as desired.

The audio speakers 142 designed for emitting bass vibrations may be included in some implementations. Placement of the audio speakers 142 may be selected to enhance the sound emitting characteristics of the gaming system 100. For example, bass speakers or additional speakers 144 may be mounted inside cabinet 105. Further, it is envisioned that in some implementations sound processing such as multichannel processing and surround sound processing are included in gaming system 100. Audio jacks for attachment of player headphones may also be provided in some implementations of gaming system 100 for the player to further enhance the audio experience of the game and to block out noise from other gaming systems.

In some implementations, the front panel 110 of cabinet 105 includes a removable panel or door, which can be opened for access to internal control system and technology components that are housed within cabinet 105 (discussed hereinbelow with respect to FIG. 2). The removable panel or door can be locked in some implementations. The front panel 110 may be flanked on vertical sides by cabinet side panel extensions 146 which serve to define a space below the player interaction area 112 for players to place their feet and legs while they are playing the gaming system 100 in a seated position. A foot rest 148, which may be cushioned, can positioned below the player interaction area 112 to enhance a player's ergonomic comfort while playing the gaming system 100. In some implementations, the edges of the player interaction area 112 may be ergonomically cushioned as well.

The gaming system 100 may be constructed using other suitable alternative forms and styles of gaming system housings that are not shown. For example, the cabinet 105 may have fewer or greater number of display devices for displaying games and game-related information to the player. If multiple display devices are used, the display devices may be of similar size, shape, and orientation or the display devices may be divergent from each other in one or more of their respective characteristics. The one or more display devices can be supported by, mounted upon, or contained within the cabinet 105 which can comprise a variety of shapes, sizes, and forms. The cabinet 105 can: protect and house the operational electronics; adequately support the display(s) in a position easily viewable for a seated or standing player, as necessary; and/or provide an easy location and support for all necessary player input/output systems, including gaming control interactions and wagering interactions. For example, in some implementations the gaming system 100 may include a housing style referred to as a “slant top” gaming device that is designed to be operated with the player comfortably seated. In this arrangement, generally, the gaming display(s) and all player input and output controls are located on a low, wide, surface that extends forwardly from the player on a horizontal plane and then slopes upwardly and away from the player's seated location.

In some implementations, housing styles of the cabinet 105 of gaming system 100 may include bar top or table top housing arrangements. These housings are generally small enough to be placed on top of an existing bar or table while providing the requisite gaming system housing functions of protection of/access to gaming electronics, displays, and player input and output functions described above.

In some implementations, the cabinet 105 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

FIG. 2 shows a functional block diagram illustrating an example of a game controller 200 of a gaming system 100 in accordance with aspects of the present disclosure. The gaming system 100 can include a cabinet 105, one or more player input devices 115, one or more value acceptance devices 117a and distribution devices 117b, one or more display devices 120, 130, and 134, a cabinet top light 128, accent lighting 138, and one or more audio speakers 142, which can be the same or similar to that previously described herein. Additionally, implementations of the game controller 200 may include one or more processors 202, one or more memory devices 204 (e.g., random access memory, read only memory, etc.), one or more game modules 205, one or more input/output (I/O) controllers 206, one or more random number generators 207, one or more network interfaces 210, one or more communication channels 211 (e.g., a data bus), one or more video processors 216, one or more lighting controllers 218, and one or more audio controllers 220. In accordance with aspects of the present disclosure, the game controller 200 is configured to perform specialized game functions and operations, consistent with the implementations described herein. The functional elements shown in FIG. 2 cooperate, on a broad and general level, to function as a gaming system providing the functionality and operations detailed below. Such functionality and operations can be embodied in hardware, software, or a combination thereof. It is understood that the below described hardware includes the structures described, as well as the functional or operational equivalents of such structures. Further, it is understood that the below-described functions and operations can be performed by hardware, digital circuitry, computer software, computer firmware, or functionally equivalent combinations thereof.

The processor 202 can be one or more general-purpose processors, special-purpose processors, or other programmable data processing apparatuses providing the functionality and operations detailed herein. In some implementations, the processor 202 is specially configured with arithmetic logic units and math co-processors, also known as floating point units, for executing one or more games consistent with the various implementations disclosed herein. In some implementations, the processor 202 includes registers for holding instructions or other data, and cache memory for storing data for faster operation thereupon.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

The memory device 204 and storage system 212 can be operatively and/or communicatively connected to the processor 202. In some implementations, the memory device 204 and/or the storage system 212 includes one or more types of memory structures. For example, the memory structures can include random access memory (RAMs) units, read only memory (ROMs), flash memory (e.g., solid state drives (SSDs)), electrically erasable/programmable read only memory (EEPROMs), etc. It should be appreciated that in some implementations, communication between the memory device 204, the storage system 212, and the processor 202 or another controller, encompasses the processor or controller accessing the memory device 204 and/or the storage system 212, exchanging data with the memory device 204 and/or the storage system 212 (e.g., reading/writing data to the memory device 204), or storing data to the memory device 204 and/or the storage system 212.

The memory device 204 and/or the storage system 212 may store program code, game code (collectively the “code” or “program instructions,” such as game module 205), and operational data (e.g., game info 213, symbols 214, and pay tables 215, or other suitable data) used in the operations of the game controller 200 to provide a gaming system that executes the gaming functions described hereinbelow. In an alternative implementation, the code and the operational data for the operation of the game controller 200 may be stored in a distributed manner such that some code is stored in memory device 204 (or storage system 212) and other code is stored remotely from the game controller 200. In some implementations, the code and the operational data used the operation of the game controller 200 includes, for example, basic input and output function data, instruction fetching data, bus and network communication protocol data, and like data for an operational gaming system. In some implementations, the code (e.g., the game module 205) and the operational data (e.g., game info 213, symbols 214, and pay tables 215, or other suitable data) used for the execution of the gaming features includes, for example, game image data, game rule data, pay table data, game mode and timing data, gaming value and wager parameter data, and random or pseudo-random number generation data.

In addition to the memory device 204 described above, in some implementations, the code and operational data for the operation of the gaming system described above may be stored in the storage system 212. The storage system 212 can be removable game cartridges or flash drives, a compact disk ROM, a digital versatile disk (DVD) optical storage technology, or suitable other fixed, non-transitory computer-readable storage devices. In some implementations, part or all of the code and operational data for operation of the gaming system or for execution of the game features may be stored in a remote memory structure and be downloaded to the memory device 204 via a network connection.

In some implementations, the game controller 200 may utilize any combination of computer-readable memory devices, such as random-access memory devices (RAMs), unalterable memory devices (ROMs), and mass storage devices for securely storing and securely communicating the software components or code that facilitate game play and other functions of the game controller 200. The memory device 204 may store software components or code that include various game data and game related control and execution software. In some implementations, the software components stored in the memory device 204 may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the game controller 200.

In some implementations, the memory device 204 and the storage system 212, with the software components, code, operational data, and other information may be secured and authenticated by authentication software stored in an unalterable memory device within the housing of the game controller 200. The game controller 200 may also include application specific integrated circuits (ASICs) to perform the security and authentication functions. At various time or events, such as before each play of a game, at a predetermined interval, upon transfer of any game data or any software components from a mass storage to the memory device 204, or upon demand, the game controller 200 (using a processor such as a processor 202 or a separate ASIC) may execute an authentication routine and perform an authentication of any software component or other data of the game controller 200. In some implementations, the software components of the gaming system 100 and game controller 200 may be prepared for authentication via creation and storage of an encrypted signature unique to one or more of the software components.

In some implementations, an encrypted signature may be created by utilizing a hash function on a software component or code to form a message digest (e.g., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming system software component, for example, in a mass storage device or an unalterable memory. During a software component authentication, the gaming system 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the game controller 200 may allow game play to proceed. In some implementations, when the message digests do not match, the game controller 200 may determine that the software component under authentication may be corrupted or fraudulent and game play may be halted. It should be appreciated that the game controller 200 may perform other suitable security and authentication checks on the game data or software components. Such authentication and security devices and functions are unique to gaming and casino industry to minimize or prevent fraud in gaming devices and gaming systems.

For a player to interact with the gaming system 100, the game controller 200 receives and processes player inputs from, e.g., input devices 115, and the game controller 200 causes processed results to be output or communicated to the player. In some implementations, the player inputs are recognized and processed or directed for processing by input/output (I/O) controller 206. Further, the I/O controller 206 may process and direct player outputs for communication to the player. The I/O controller 206 can function as the intermediary between the processor 202 and one or more input devices to control information and data flow therebetween. The I/O controller 206 may also function as the intermediary between the processor 202 and one or more output devices to control information and data flow therebetween. The I/O controller 206 is configured to understand the communication and operational details (such as hardware addresses) for the attached input devices and output devices. In this manner, processor 202 can be freed from the operational details of the peripheral I/O devices in some implementations. For example, in some implementations where an input or output device is changed or upgraded, the I/O controller 206 can be changed or updated without changing other gaming system components.

In some implementations, a player deposits value into a gaming system by inserting some form of currency or value into a value acceptor 225 for game play. Alternatively, a player deposits value into a gaming system by inserting an encoded paper ticket into a value acceptor 225 for game play in some implementations. The value acceptor 225 can be combined with a currency reader and validator, and a code reader for reading value encoded on paper tickets. In some implementations, the gaming system 100 may include different hardware for the paper ticket reader from the currency reader and validator. The value acceptor 225 may read, validate and communicate the amount of the inserted value to the processor 202. The processor 202 can establish a gaming credit balance for the player based on the communication from the value acceptor 225. The processor 202 can also communicate the player's credit balance on a credit balance meter display of the gaming system 100. During game play, the processor 202 may process a player's wagers and determine an amount of credits to debit from the player's credit balance. When a winning outcome is obtained, the processor 202 is configured to determine an amount of credits to add to the player's credit balance. It should be appreciated that the gaming system 100 may use one or more different processors to perform such calculations.

As previously mentioned with respect to FIG. 1, gaming system may use one or more of a variety of value acceptance systems. In some implementations, the value acceptor 225 could include magnetic strip or chip card readers to accept and transfer value. The value acceptor 225 may also be configured to accept and transfer non-traditional currencies such as digital currencies. In these implementations, I/O controller 206, a processor 202, or both may be configured with appropriate control instructions to communicate with the value acceptor 225 and extract value from the inserted item containing value. In some implementations, use of a magnetic strip or embedded chip card, for example a bank card, for value insertion requires the processor 202 to communicate, via network interface 210, with devices external to a gaming system 100.

In some implementations, a card reader 227 may be included in gaming system 100 to accept player loyalty cards. For example, the card reader 227 can extract account identifying information from the card and utilizes this information to access the associated account information stored remotely via the network interface 210. In implementations where player loyalty/player tracking systems are used with the gaming system 100, a player's loyalty account and record of gaming activity can be stored in a networked storage location or database. In some implementations, the processor 202 is configured to record the player's gaming activity in the memory device 204 and/or the storage system 212 during the duration of loyalty card insertion. When the loyalty card is removed from the card reader 227, recorded gaming activity is uploaded, via the network interface 210, to the remote storage location associated with the player's account in some implementations. In this manner, the player's gaming activity can be further processed and analyzed, and the player can be awarded loyalty rewards based upon his activity data at the gaming system 100.

In various implementations, the input devices 115 receive a player's game inputs and communicates the player's game inputs to the processor 202. The player's game inputs may include, but are not limited to, wager amounts, pay line selections, game control signals, game selections, and cash-out requests/signals. In some implementations, the input device 115 may generate signals/requests based on button presses, touch screen activations, or voice control. In some implementations, the player-initiated signals can be communicated to the processor 202 by the I/O controller 206. Further, the player-initiated signals may direct and inform execution of the game instructions stored in the memory device 204 and configured to be executed by the processor 202 in some implementations.

In some implementations, the gaming system 100 may include mechanical game reels and other electro-mechanical components to provide game displays and game outcomes (not shown). For example, mechanical game reels (e.g., mechanical game reels rotatable about a common axis) may include indicia or symbols fixedly positioned around the periphery of the mechanical game reels. The indicia or symbols fixedly positioned around the periphery of a mechanical game reel may form a reel strip. The indicia or symbols fixedly positioned on reel strip may comprise a set of symbols for that reel strip or reel. The indicia or symbols on the mechanical game reels are generally associated with separate, detectable reel stop positions. In some implementations, the mechanical game reels can be set into a spinning/rotation motion by pulling a lever or pushing a button of the gaming system 100. In some implementations, the gaming system 100 can stop the game reels by allowing the mechanical game reels to stop naturally, or actuating a suitable mechanical or electro-mechanical reel brake on a random timing basis. When the mechanical game reels stop rotating, the gaming system 100 may, using suitable detection mechanisms, determine one or more displayed stop positions of the mechanical game reels. Since the displayed stop positions of the mechanical game reels can be associated with respective indicia or symbols, the gaming system 100 can determine what combination of indicia or symbols are displayed at the stop positions. The gaming system 100 can also determine whether the displayed indicia or symbols result in one or more winning symbols and/or winning symbol combinations for a game outcome.

In some implementations, the displayed stop positions (e.g., corresponding to displayed indicia) can be determined using random numbers associated with the displayed stop positions/indicia/symbols of the mechanical reels. In some implementations, the processor 202 is configured to execute stored program code and instructions which generate one or more random numbers or pseudo-random numbers for determining the displayed stop positions of the mechanical reels. The gaming system 100 can use the randomly generated numbers to determine which stop positions of the reels should be displayed for a game outcome.

In some implementations, a random number generator (RNG) 207 is a software module configured to be executed by the processor 202 for the generation of a true random or pseudo-random number. The code for RNG 207 may be stored in the memory device 204 or the storage system 212. The RNG 207 generates random numbers for use by the gaming system 100 during game execution. In some implementations, the gaming system 100 can utilize one or more random numbers for the random selection of one or more symbols (e.g., stop positions) along mechanical game reels.

In some implementations, the gaming system 100 uses video-based reels as simulations of the mechanical reels to provide game displays of game outcomes. In some implementations, the video-based reels are used in place of mechanical reels. In some implementations, the video-based reels are used in conjunction with mechanical reels or other mechanical components. Like a mechanical game reel, a video-based reel can be associated with a reel strip, where the reel strip includes a set of symbols or indicia. The set of symbols or indicia for a reel strip may be fixed or dynamic in various implementations. In some implementations, indicia or symbols can include, but are not limited to, numbers, letters, geometric figures, symbols, images, character, animations, blank symbols (e.g., the absence of symbols), or any other suitable graphical depiction. The gaming system 100 may include one or more video-based reels for a game. The gaming system 100 may include a particular reel strip associated with a particular video-based reel. In some implementations, each video-based reel can be associated with a separate reel strip (e.g., a separate set of symbols). The reel strips can be the same or different for different video-based reels. It should be appreciated that the language “reel strip(s)” is used merely for illustration purposes throughout this disclosure. In some implementations, predetermined reels strips may be used. In other implementations, a reel strip is a representation of a set of symbols, where symbols in the set of symbols are associated with a probability of being determined or generated for display in the visible symbol display areas of a video-based reel. Different reel strips (e.g., different sets of symbols) may include the same symbols associated with the same or different probabilities of being determined or generated. In some implementations, different reel strips may include different symbols. It should be appreciated that in some implementations, indicia or symbols can be used independently of a video-based reel. That is, in some implementations, games on gaming system 100 do not use video-based reels or reel strips for displaying of game outcomes. In some implementations, where games on gaming system 100 do not use video-base reels or reel strips, the gaming system may also use random number determinations for game outcomes.

Returning to random number generation, symbols in the reel strips or sets of symbols can be associated with numbers for video-based reels, (or associated with reel stop positions of mechanical game reels). In some implementations, when the RNG 207 selects a number, a processor in conjunction with the memory devices 204 of the gaming system 100 can correlate the selected number to an associated symbol (or respective reel stop position) to determine what symbol (or reel stop position) has been randomly selected. In various implementations, once symbols (or reel stop positions) are randomly selected based upon the random numbers generated by the RNG 207, the processor 202 can evaluate the displayed patterns of symbols or randomly determined numbers to determine one or more game outcomes. It should be appreciated that in some implementations, gaming system 100 may include a hardware based random number generator that is in communication with processor 202 to supply random numbers for random game symbol determination purposes. The hardware based random number generator may be incorporated into the processor 202 or can be separate from the processor 202.

In some implementations, displayed symbols on the reels can be derived from a central determination gaming system seed value. In some implementations, a remotely generated (e.g., generated via a central server; generated via one or more networked peer gaming systems) seed value, or remotely generated seed values, may be received by the gaming system and utilized to derive one, some, or all gaming symbol display outcomes for a play of a game. In some implementations, seed values may be randomly selected from predetermined fixed seed value pools, and the seed values may be deterministic of a particular game outcome. That is, in some implementations, the gaming system may obtain a random number or seed from a remote RNG, such as an RNG located at another gaming system or at a remote server. In such an example, the gaming system may use the remotely obtained random number or seed to derive one or more of the displayed symbol outcomes (e.g., base game outcomes, bonus game outcomes, feature game outcomes). In some implementations, the seed value may be randomly determined locally by the gaming system. In some implementations, the remotely or locally determined seed values can be used to select one or more predetermined outcomes (e.g., from one or more pools of predetermined outcomes), which result in displayed symbols on the reels. In some implementations, the one or more pools of predetermined outcomes can be store locally at the gaming system 100 or remotely (e.g., at a central server; at one or more networked peer gaming systems). It should be appreciated that the use of seed value is another form of determining or generating symbols using an RNG. It should further be appreciated that a single sample from a RNG either o remote may generate a plurality of symbols in a plurality of game states.

Returning to FIG. 2, the game controller 200 controls the function and output of output devices utilized by a gaming system. In various implementations, the I/O controller 206 serves as an interface unit between the processor 202 and output devices, such as video processor 216, cabinet lighting controller 218, audio controller 220, and value dispenser 222.

In some implementations, the video processor 216 communicates with the processor 202 to render at least some of the game graphics, video displays, and information on one or more video display devices (e.g., game display devices 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video game reels containing symbol sets.

It should be appreciated that in certain other implementations where gaming system 100 includes physical mechanical game reels to display game symbols or other game features, reel controllers and stepper motors can be provided in lieu of or in addition to video processor 216.

In implementations which utilize cabinet lighting as described with respect to FIG. 1, a cabinet lighting controller 218 may be utilized to coordinate and control the color and timing of cabinet lighting displays with processor 202. In certain implementations which utilize sound design, processor 202 may utilize audio controller 220 to coordinate and control the sound emissions. In some implementations, audio controller 220 may include one or more audio processing cards for generating sound and for driving the one, two or more speakers 142 that may be included with the gaming system 100.

In various implementations, players may request their remaining credit value by selecting one of the input devices 115, which in turn makes a request or initiates a signal that is communicated to the processor 202, such as via the I/O controller 206. In some implementations, the signal triggers a readout of the player's credit balance from a credit balance meter and the processor 202 initiates a value dispensing signal which, in turn, can be communicated to the value dispenser 222. In some implementations, the value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the processor 202 can direct the value dispenser 222 to issue to the player an appropriate amount of coin or bills directly to the player. Additionally, or alternatively, in some implementations, the player may have the option to electronically direct the credit value to an account associated with the player. It should be appreciated that any suitable combination of forgoing may be available at gaming system 100.

In some implementations, the game controller 200 may communicate with one or more devices outside the gaming system 100. For example, gaming system 100 may be connected to a larger network via a local area network (LAN) or a wide area network (WAN). The game controller 200 may communicate with one or more central servers, controllers, or remote devices to execute games, establish credit balances, participate in progressive jackpots, etc. In some implementations, network communications and connections can be accomplished via a network interface 210. Network interface 210 can be a digital circuit board or card installed in game controller 200 to provide network communications with external devices. Network interface 210 may include wired and/or wireless communication hardware.

In some implementations, various additional features and functions are performed by the game controller 200. For example, the game controller 200 may be specially configured with software to track game play events that occur on the gaming system 100. In some implementations, the game controller 200 may audit recorded monetary transactions, including wager amounts, game outcomes, game winnings, and game payouts that occur through the value dispenser 222. Further, some implementations of gaming system may include security software to assist in protecting the gaming system 100 from tampering or alteration attempts.

### Games Including Non-Interacting Reels

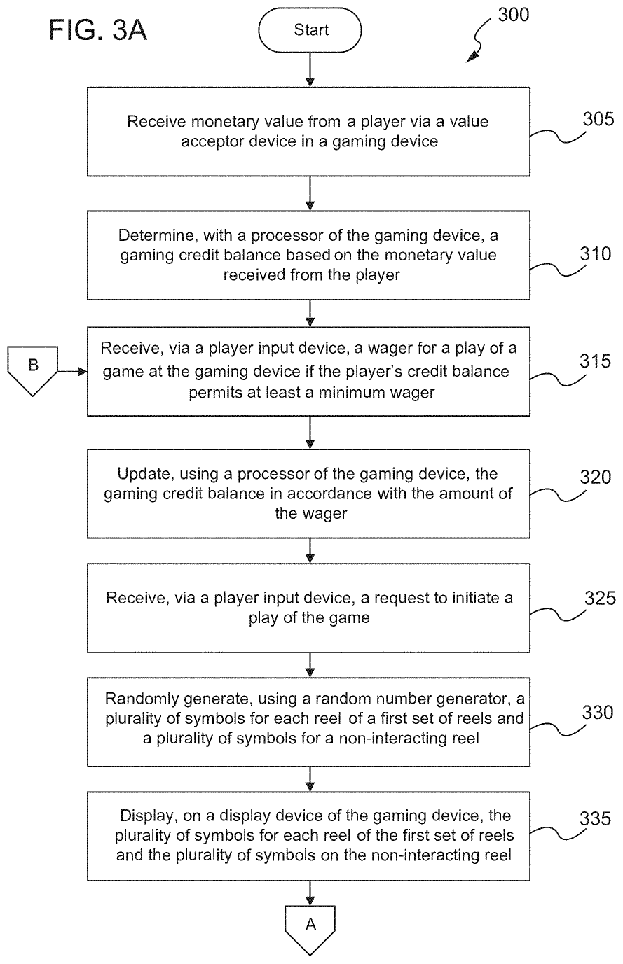

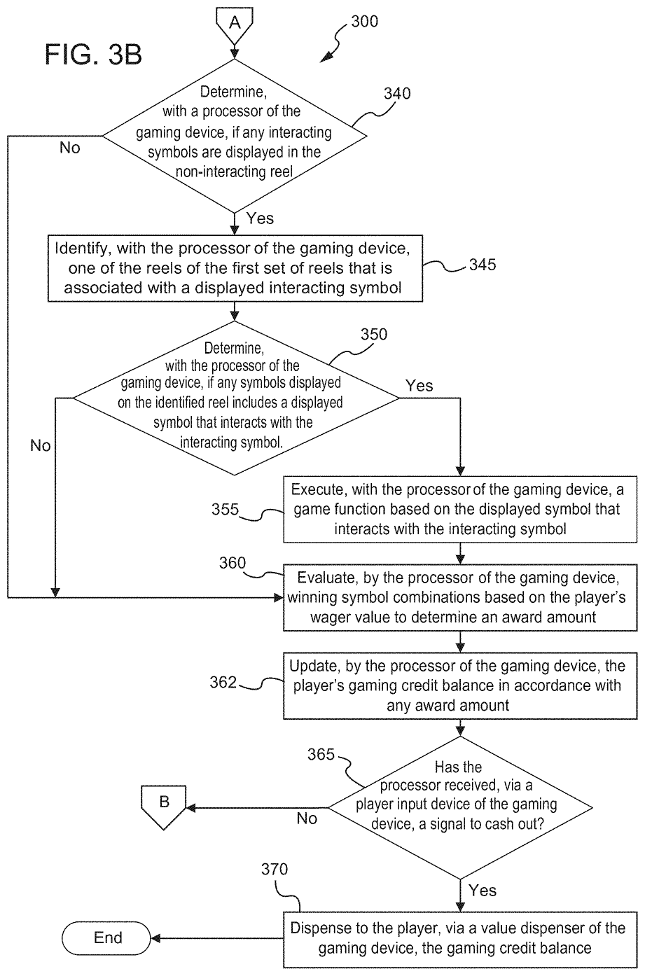

FIGS. 3-8, 9, and 10A-10D describe some implementations which provide a gaming system and method including at least one non-interacting reel having one or more interacting symbols.

FIGS. 3A and 3B illustrate a flowchart of operation 300, which is one implementation of the gaming system and method. In this implementation, at least one processor of the gaming system may be configured, via instructions stored in a memory device, to perform the operation 300. However, it should be appreciated that other suitable variations of operation 300 are possible. For example, in one implementation, fewer or one or more additional operations (not shown) may be employed in operation 300 of the gaming system and method.

FIG. 3A illustrates one implementation in which the gaming system receives a monetary value from a player to initiate operation 300. As indicated in block 305, the gaming system may receive monetary value from a player via a value acceptor device associated with the gaming system. The value acceptor device can be any suitable value acceptor device as discussed above. The value acceptor device may also, in one implementation, be disposed in a gaming system or in communication with the gaming system.

In one implementation, the gaming system may determine a credit balance based on the monetary value received from the player at a value acceptor device as indicated in block 310. The gaming system may determine the gaming credit balance for the player with a processor of the gaming system. The gaming credit balance may be based at least in part on the monetary value received from the player at the value acceptor device.

In one implementation, the gaming system may receive a wager for a play of a game at the gaming system. Block 315 of FIG. 3A illustrates one implementation where the player's wager may be received via a player input device. The gaming system may allow a player to place a minimum wager, a maximum wager, or any suitable wager amount. Depending on the wager amount, the gaming system may also enable the player to select pay lines across displayed symbol positions on reels in the game. In one implementation, the gaming system may determine whether the player has provided enough credits to enable the player's selected wager. The gaming system may prevent the player from placing the wager and starting a play of a game if the player's credit balance is not large enough to support the player's selected wager. If enough credits are not available in the player's credit balance, the gaming system may enable the player to insert additional value to obtain the minimum credit level for the wager or to cash out of the gaming system.

In one implementation, the gaming system may use a processor of the gaming system to update a gaming credit balance. The credit balance may be updated in accordance with the player's wager amount as indicated in block 320. In some implementations, the credit balance is not updated until a later time.

Block 325 illustrates one implementation in which the gaming system may receive a request to initiate a play of a game. The request to initiate a play of a game may be received from a player via a player input device. For example, the player may press a spin button on the gaming system to start spinning gaming reels or to cause the gaming system to generate images for display in the game.

In one implementation, the gaming system may use a random number generator to randomly generate a plurality of symbols for each game reel of a first set of reels as indicated in block 330. The symbols for the first set of reels may come from one or more first sets of symbols. In one implementation, the gaming system may also use a random number generator to randomly generate a plurality of symbols for a non-interacting reel as also indicated in block 330. The symbols for the non-interacting reel may come from one or more second sets of symbols that includes at least one interacting symbol. As used herein, the random number generation may refer to pseudo-random or true-random number generation depending on the module used for the random number generation.

In one implementation, the gaming system may cause a display device to display the plurality of symbols generated for the first set of reels as indicated in block 335. In one implementation, the gaming system may also cause a display device to display the plurality of symbols for the non-interacting reel as also indicated in block 335. In some implementations, the gaming system may always generate at least one interacting symbol for the non-interacting reel. In other implementations, the gaming system may generate zero, one or more interacting symbols for the non-interacting reel. In one implementation, the gaming system will associate each symbol display area of the non-interacting reel with one of the reels of the first set of reels. When the gaming system generates and displays symbols on the non-interacting reel, the displayed symbols may also each be associated with one of the reels of the first set of reels in accordance with the displayed symbols' positions on the non-interacting reel. That is, in some implementations, a displayed symbol on the non-interacting reel will be associated with the same reel as the symbol display area where the displayed symbol is displayed.

Turning now to FIG. 3B and block 340, in one implementation the gaming system may determine if any interacting symbols were generated and displayed on the non-interacting reel. In one implementation, if the gaming system determines that no interacting symbols were generated and displayed in the non-interacting reel, operation 300 may proceed directly to the evaluation illustrated in block 360. It should be appreciated that the gaming system may determine if any interacting symbols were generated on the non-interacting reel prior to displaying the symbols. It should further be appreciated that the gaming system may determine if any interacting symbols were generated on the non-interacting reel at any suitable time.

In one implementation, as illustrated in block 345, if the gaming system determines that at least one interacting symbol was generated and displayed in the non-interacting reel, the gaming system may identify which reel of the first set of reels is associated with the generated at least one interacting symbol. In other implementations, the gaming system may determine which reel of the first set of reels is associated with a symbol display area occupied by the at least one interacting symbol to reach the same determination.

In one implementation as illustrated in block 350, the gaming system may determine, with the processor, whether any symbols displayed on the identified reel includes a displayed symbol that interacts with the interacting symbol. In some implementations, the symbol that interacts with an interacting symbol is predetermined. In some implementations, the symbol that interacts with an interacting symbol is randomly determined before or during a play of the game. In some implementations, the symbol that interacts with an interacting symbol is selected from the first set of symbols. In some implementations, the symbol that interacts with the interacting symbol is selected of a subset of the first set of symbols. In some implementations, different symbols will interact differently with the interacting symbol. Any suitable combinations of the above symbol interactions can be used.

If no symbols displayed on the identified reel include a symbol that interacts with the interacting symbol, the gaming system may move to block 360. On the other hand, if at least one symbol displayed on the identified reel is determined to interact with the interacting symbol, the gaming system may execute, with a processor, a game function based on the interaction between the two symbols in accordance with block 355. In one implementation, the interaction may include the gaming system causing one displayed symbol on the identified reel of the first set of reels to change all the other displayed symbols on the same identified reel into the symbol determined to interact with the interacting symbol. In another implementation, the symbol interaction may include triggering a bonus game or a predetermined number of free spins. The gaming system may also use the processor to determine any of the alterations to the symbols in the first set of symbols based on the interaction. It should be appreciated that the gaming system can execute any suitable interaction.

The gaming system may evaluate, in one implementation, the displayed symbol combinations on the first set of reels for winning symbol combinations as indicated in block 360. The availability of certain winning symbol combinations may be based on the amount the player wagered in block 315. In one implementation, the gaming system may evaluate one or more pay lines via a processor of the gaming system. In this example implementation, the gaming system may determine an award amount based on winning symbol combinations that are formed along wagered pay lines.

Block 362 illustrates one implementation in which the gaming system may update, with a processor of the gaming system, the gaming credit balance in accordance with any award amount determined in block 360.

In one implementation, after receiving a signal to end game play from a player via an input device as illustrated in block 365, the gaming system may dispense the gaming credit balance to the player via a value dispenser, as indicated in block 362. In one implementation, if the processor has not received a signal to end game play via a player input device, the process of operation 300 may return to block 315 to receive another wager for another play of a game at the gaming system. However, in one implementation, the wager may not be accepted if the player's credit balance includes less credits than the player's selected wager amount.

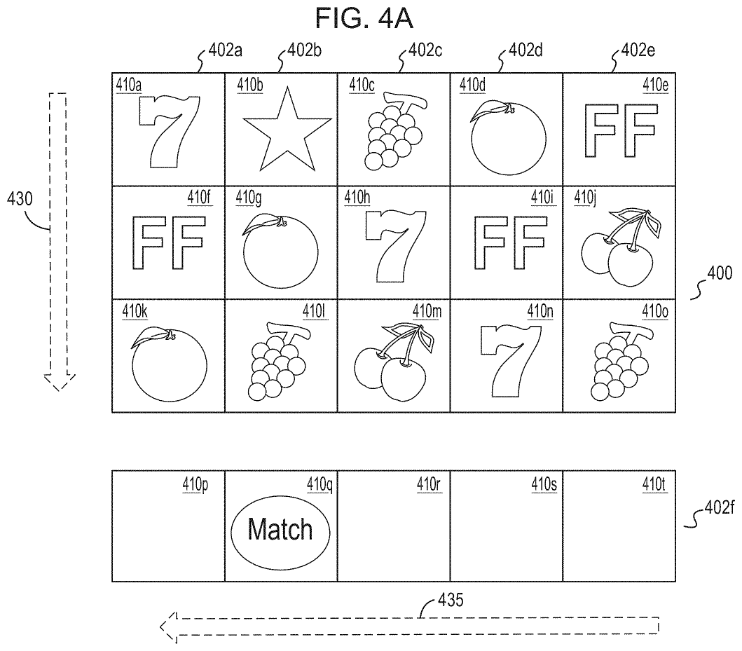

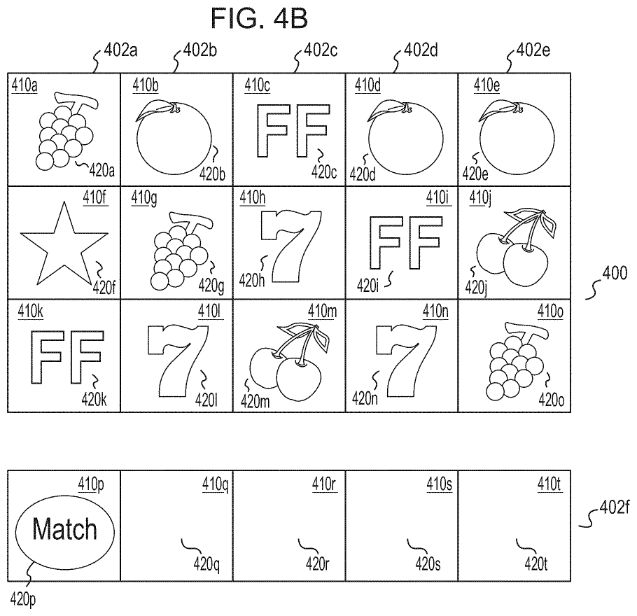

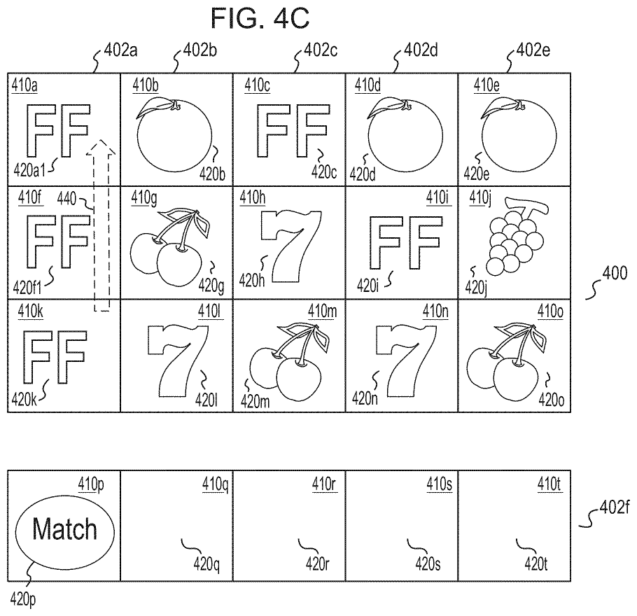

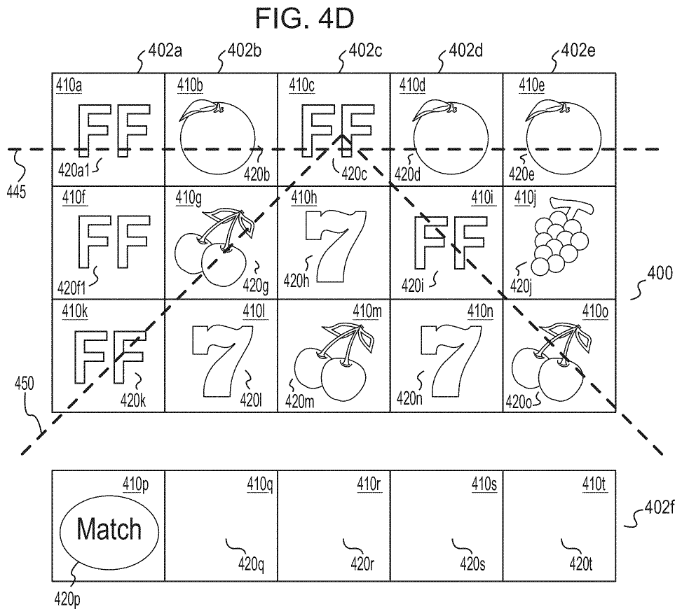

FIGS. 4A, 4B, 4C, and 4D illustrate screen shots of one implementation of a gaming system having a non-interacting reel and one or more interacting symbols.

FIG. 4A illustrates one implementation of a game display 400 that is displayed by the gaming system on a display device of the game device 100. In one implementation, game display 400 may be displayed on first display 122 of gaming device 100 illustrated in FIG. 1. However, any other suitable display may be used. The game display 400 displays a set of a plurality of reels 402a, 402b, 402c, 402d, 402e, and 402f as illustrated in FIG. 4A. As also illustrated in FIG. 4A, the reels 402a-402e are displayed substantially side by side, while reel 402f is depicted as separated from and positioned below reels 402a-402e. It should be appreciated that reel 402f can be displayed substantially close with reels 402a-402e in some implementations where little to no separation is discernable. In such examples, the gaming system may be configured to display some indication that enables a player to discern a difference between reel 402f and reels 402a-402e. It should be appreciated that reels 402a-402f can alternatively be displayed with any suitable amount of separation or no separation.

The plurality of reels 402a-402e are each associated with a first set of symbols, where the first set of symbols includes a plurality of symbols. Each reel 402a-402e is associated with a plurality of symbols of the first set of symbols. Each reel 402a-402e can also be associated with the same or a different plurality of symbol combinations from the first set of symbols. Reel 402f is associated with a second set of symbols, where the second set of symbols includes at least one interacting symbol.

The first set of symbols may include numbers, letters, geometric figures, symbols, images, character, blank symbols (e.g., the absence of symbols), animations, or any other suitable graphical depiction. In one implementation, the second set of symbols includes at least one interacting symbol such as a directional arrow. However, it should be appreciated that the second set of symbols may also include any suitable symbol such as numbers, letters, geometric figures, symbols, images, characters, blank symbols (e.g., the absence of symbols), animations, or any other suitable graphical depiction.

Symbols in the first set of symbols may be associated with special features. These special features may trigger the gaming system to perform a particular function when such symbols are visibly displayed on a stopped reel. In one example, the appearance of a symbol designated to trigger a bonus game may cause the gaming system to execute a bonus game during or after a play of a game. In another example, the appearance of a symbol designated to trigger free spins may cause the gaming system to execute a certain number of free spins. In another example, one of the symbols in the first set of symbols can be a Flipside Frenzy symbol such as symbol 420k shown in FIG. 4B. The Flipside Frenzy symbol is a type of wild symbol that can mimic or substitute for any of the other plurality of symbols of the first set of symbols. That is, the appearance of a Flipside Frenzy symbol on a stopped reel may cause the gaming system to evaluate the Flipside Frenzy symbol like one of the other symbols along a wagered pay line for purposes of determining a winning symbol combination. In another implementation, the gaming system may cause the Flipside Frenzy symbol to flip or turn a predetermined number of degrees (e.g., approximately 180 degrees or other suitable number of degrees) to reveal a different symbol. In such an implementation, the different symbol may cause the gaming system to change certain other visible symbols around the different symbol into the different symbol. In another implementation, gaming system may cause other visible symbols on the reel displaying the Flipside Frenzy symbol to change into the Flipside Frenzy symbol. In some implementations, the gaming system does not execute any functions associated with the Flipside Frenzy symbol unless another predetermined symbol is visibly displayed. For example, the gaming system may not execute any described functions associated with the Flipside Frenzy symbol unless an interacting symbol is visibly displayed on reel 402f. In one such implementation, the interacting symbol must appear in a symbol display position associated with the column or reel displaying the Flipside Frenzy symbol before the gaming system will execute any functions associated with the Flipside Frenzy symbol.

In one implementation, an interacting symbol is a symbol that can identify a column or reel of visible symbols. The appearance of an interacting symbol can identify to a player and the gaming system that certain interactions may occur between an interacting symbol and symbols in a column or reel associated with the interacting symbol. For example, an interacting symbol 420p (the match symbol) indicates the first column or reel 402a in FIG. 4B. Based on an association between the interacting symbol 420p and reel 402a, the gaming system may evaluate the symbols along this reel or column to determine if any symbols will interact with interacting symbol 420p (which may cause the gaming system to execute additional game functions). For example, the gaming system may be specially programmed to cause symbol 420f and 420a of reel 402a in FIG. 4B to convert into a Flipside Frenzy symbol because the Flipside Frenzy symbol 420k appeared in the reel 402a which is associated with interacting symbol 420p (or symbol display area 410p). In one example, the Flipside Frenzy symbol may interact with the match symbol 420p to cause the Flipside Frenzy symbol to overwrite or replace symbols 420a and 420f. On the other hand, as shown in FIG. 4A, while a Flipside Frenzy symbol is also displayed in symbol display area 410e, if the Flipside Frenzy symbol is not in a column or reel associated with a match symbol (symbol display area 410t is a blank symbol), the gaming system may determine not to change symbols 420j and 420o into Flipside Frenzy symbols.

In other implementations, symbols other than the Flipside Frenzy symbol can be used in conjunction with the interacting symbol for the same or other interactions and cause the gaming system to execute additional game functions. In still other implementations, the interacting symbol may indicate a column or reel as well as a type of action to perform based upon the content displayed in the interacting symbol. For example, the content of the interacting symbol may include a payout multiplier. The gaming system may use the payout multiplier to determine how many credits the player will win. In another example, the interacting symbol may include a number as the content. The number displayed with the interacting symbol may determine how many symbols in a reel the Flipside Frenzy symbol can change. Various game operation implementations are described in greater detail below.

Returning now to FIG. 4A, the game display 400 depicts a plurality of symbol display areas 410a, 410b, 410c, 410d, 410e, 410f, 410g, 410h, 410i, 410j, 410k, 410l, 410m, 410n, 410o, 410p, 410q, 410r, 410s, and 410t. These plurality of symbol display areas can be associated in a manner that provides the appearance of game reels. As illustrated in FIG. 4A, symbol display areas 410a, 410b, 410c, 410d, 410e, 410f, 410g, 410h, 410i, 410j, 410k, 410l, 410m, 410n, 410o are associated in a manner that provides the appearance of a first set of five game reels. In one implementation, the plurality of symbol display areas that provide the appearance of five game reels may be arranged in a manner that visibly shows three symbol positions of each of the five game reels. For example, the symbol display areas 410a-410o are each associated with positions on reels 402a-402e. The symbol display areas 410p-410t are associated with positions on reel 402f. As shown in FIG. 4A, symbol display areas 410a, 410f, and 410k are associated with reel 402a; symbol display areas 410b, 410g, and 410l are associated with reel 402b; symbol display areas 410c, 410h, and 410m are associated with reel 402c; symbol display areas 410d, 410i, and 410n are associated with reel 402d; symbol display areas 410e, 410j, and 410o are associated with reel 402e; and symbol display areas 410p, 410q, 410r, 410s, and 410t are associated with reel 402f. The arrangement illustrated in the implementation of FIG. 4A thus creates a first visible display area of the reels 402a-402e comprising three visible symbol positions for each reel. When viewed together, reels 402a-402e appear like a 3-row by 5-column reel array in display 400 and reel 402f appears like a 1-row by 5 column reel array in display 400. In other implementations, smaller or larger visible areas of the reels can be displayed. That is, the reels 402a-402f may show a fewer number of visible symbols or show a larger number of visible symbols for the reels. While symbol display areas are illustrated with defined areas or boxes, it should be appreciated that in some implementations, the defined areas or boxes are not visible to the player.

Each reel 402a-402e may display a plurality of symbols from the first set of symbols in their respective symbol display areas as illustrated in FIG. 4A. Reel 402f may display one or more symbols from the second set of symbols in its symbol display areas illustrated in FIG. 4A. As shown in FIG. 4A, during a play of a game, each reel 402a-402e may show an animation of spinning reels spinning in the direction indicated by arrow 430 and reel 402f may show an animation of a spinning reel spinning in the direction indicated by arrow 435.

In some implementations, the symbol display areas of reel 402f are each associated with at least one column or reel, such as reels 402a-402e. For example, in FIG. 4A, the gaming system may associate symbol display area 410p with reel 402a; the gaming system may associate symbol display area 410q with reel 402b; the gaming system may associate symbol display area 410r with reel 402c; the gaming system may associate symbol display area 410s with reel 402d; and the gaming system may associate symbol display area 410t with reel 402e. Thus, in one implementation, the association is easy to visualize because the symbol display areas of reel 402f line up substantially with reels 402a-402e. In other implementations, the gaming system may randomly determine how the symbol display areas of reel 402f will be associated with each of the reels 402a-402e. When symbol display areas 410p-410t of reel 402f display symbols, these displayed symbols may also be associated with the same column or reel as their corresponding symbol display areas 410p-410t.

FIG. 4A illustrates one implementation of display area 400 showing a game screen prior to executing a play of a game with a plurality of symbols generated for reels 402a-402e and a plurality of symbols generated for reel 402f.

Turning now to FIG. 4B, to start a gaming session, a player provides the gaming system with a deposit of value, using one of the suitable value acceptor devices described above. The gaming system receives and validates the player's deposit of value. The gaming system may then issue credits (e.g., gaming credits) to the player based on the received value. The credits enable the player to initiate a play of a game and also to place wagers on a play of the game. The gaming system may provide a visual indication of the player's credit balance to the player as discussed above.

To initiate a play of a game, the player presses one or more appropriate buttons on the gaming system to deduct credits necessary to play the game and to identify the player's wager. Along with receiving the player's wager, the gaming system may receive pay lines selections or other game features the player wishes to activate in exchange for the wager. The player may actuate a game start button or a spin button, depending on the type of game played. The gaming system may deduct the appropriate credits from the player's credit balance after the player's wager or at any suitable time.

Upon receipt of the player's wager and activation of the game start button, the gaming system may show an animation of spinning reels as indicated by direction arrows 430 and 435 of FIG. 4A for each of the reels 402a-402f. In one implementation, the gaming system randomly generates symbols 420a-420t from the first and second set of symbols for reels 402a-402f, respectively. As noted above, the gaming system may rely on random number generation performed by a pseudo RNG, a true RNG, or other hardware RNGs. The gaming system displays the generated symbols 420a-420t in symbols display areas 410a-410t as illustrated in FIG. 4B. Symbols 420a-420t displayed on reels 402a-402f illustrate the randomly generated symbols after the reels have stopped spinning. It should be noted that in some implementations, the reel spin directions may both be reversed from the shown directions or just one reel spin direction may be reversed.

As illustrated in FIG. 4B, the gaming system randomly generated and displayed symbols 420a, 420f, and 420k in symbol display areas 410a, 410f, and 410k for reel 402a. The gaming system also randomly generated and displayed symbols 420b, 420g, and 420l in symbol display areas 410b, 410g, and 410l for reel 402b; symbols 420c, 420h, and 420m in symbol display areas 410c, 410h, and 410m for reel 402c; symbols 420d, 420i, and 420n in symbol display area 410d, 410i, and 410n for reel 402d; symbols 420e, 420j, and 420o in symbol display area 410e, 410j, and 410o for reel 402e. The gaming system further randomly generated and displayed symbols 420p, 420q, 420r, 420s, 420t in symbol display areas 410p, 410q, 410r, 410s, 410t for reel 402f.

As illustrated in FIG. 4B, the gaming system generated and displayed an interacting symbol 420p and blank symbols 402q-420t for reel 402f (a non-interacting reel). As also illustrated in FIG. 4B, the gaming system generated and displayed Flipside Frenzy symbols (420k, 420c, 420i), orange symbols (420b, 420d, and 420e), grape symbols (420a, 420g, and 420o), cherry symbols (420j and 420m), and seven symbols (420h, 4201, and 420n). However, is should be appreciated that the displayed symbol combinations are merely for explanatory purposes and the gaming system may randomly generate any suitable combination of symbols based on defined symbol sets and the random number generation.

In one implementation of FIG. 4B, the gaming system performs an evaluation of the generated symbols on reels 402a-402f and determines whether to execute certain game functions based in part on interactions between symbols. In one implementation, the gaming system determines whether any interacting symbols were generated and displayed in reel 402f. In the illustrated implementation of FIG. 4B, the gaming system determines that a Match symbol 420p (an interacting symbol), was generated and displayed in position 410p of reel 402f. The gaming system may then determine which reel or column of symbols is associated with the interacting symbol 420p (or symbol display area 410p). The association between the interacting symbol (or symbol display area) and a reel determines which displayed symbols the gaming system will evaluate to determine what interactions (if any) the gaming system may execute.

In the implementation illustrated in FIG. 4B, the gaming system determines that interacting symbol 420p is associated with reel 402a. Based at least in part on this determination, the gaming system determines if any of the symbols 420a, 420f, or 420k interacts with the interacting symbol 420p. While depicted in FIG. 4B as a match symbol, an interacting symbol 420p can be any other suitable symbol or graphic. In one implementation, the interacting symbol can be an arrow graphic that points to the first reel 402a. It should be appreciated that the association between the interacting symbol 420p and the reel provides a clear acknowledgment to a player that the gaming system may evaluate and possibly execute game functions on the first reel of the visible symbols on reels 402a.

For example, the gaming system may be specially programmed to cause symbol 420f and 420a of reel 402a in FIG. 4B to convert into a Flipside Frenzy symbol because the Flipside Frenzy symbol 420k appeared in the reel 402a which is associated with interacting symbol 420p (or symbol display area 410p). Alternatively, the Flipside Frenzy symbol may interact with the match symbol 420p to cause the Flipside Frenzy symbol to overwrite or replace symbols 420a and 420f. On the other hand, as shown in FIG. 4B, while a Flipside Frenzy symbol is also visibly displayed in symbol display area 410c, if the Flipside Frenzy symbol is not in a column or reel associated with a match symbol (symbol display area 410r is a blank symbol), the gaming system may determine not to change symbols 420h and 420m into Flipside Frenzy symbols.

In one implementation, the gaming system determines (such as using processor 202) that the first reel 402a includes a Flipside Frenzy symbol 420k and also determines that a Flipside Frenzy symbol 420k interacts with the interacting symbol 420p. In this implementation, the Flipside Frenzy symbol interacts with the interacting symbol 420p to cause the gaming system to change the behavior of symbols around the Flipside Frenzy symbols. As previously discussed, many other interactions are possible.

In the implementation illustrated in FIG. 4C, the gaming system causes the Flipside Frenzy symbols 420k to expand in the direction of dotted arrow 440 to the remaining visible symbol positions on reels 402a. As is illustrated in FIG. 4B, a Flipside Frenzy symbol 420a1 and 420f1 have expanded to symbol positions 410a and 410f on reel 402a and replaced the prior symbols 420a and 420f. In some implementations, the gaming system may execute the same or different game functions based on interactions between other symbols. For example, the gaming system may execute a bonus game or a free spin based on some symbol interactions. The gaming system may execute additional game functions at the same time, in a random order, or in a particular sequence.

While the illustrations in the figures of the disclosure show symbols expanding to other symbol positions and replacing the existing symbols, other symbol interactions may be used in place of the expanding symbol shown in FIG. 4C. For example, the Flipside Frenzy symbol may grow into other symbol positions. In some implementations, the symbol in a symbol position that is slated for transformation may morph into the Flipside Frenzy symbol. In some implementations, the Flipside Frenzy symbol only impacts or changes predetermined base symbols. In some such implementations, scatter pay, bonus game triggering symbols, free spin symbols, and other symbols associated with certain special game features are not affected by the Flipside Frenzy symbol interaction. That is, in these implementations, scatter pay and other such symbols associated with special game features will not be replaced whether through expansion, growth, morphing, or other suitable changes, while base game symbols are affected. In other implementations, the Flipside Frenzy symbol interaction can change all symbols without regard to a symbol's association with special game features.

In yet other implementations, the Flipside Frenzy symbols may also transform into one or more different symbols based on an interaction with the interacting symbols. The transformation may include animating the Flipside Frenzy symbol in such a manner as to appear to spin about an axis or flip sides to a different symbol.

It should be appreciated that the ability to alter the behavior of the Flipside Frenzy symbol and other symbols is not limited to the Flipside Frenzy symbol. Any suitable symbol can be designated to perform similar game functions noted herein when interacting with an interacting symbol. It should also be appreciated that the gaming system can also be specially configured to execute other interactions between symbols to increase a player's anticipation of increased awards and further increase the player's enjoyment of the game.

If the gaming system determines that no other symbols in reel 402a interact with symbol 420p, the gaming device may evaluate the displayed symbol combinations for winning symbol combinations. It should be appreciated that the gaming device can evaluate the displayed symbols for winning combinations at any time. For example, the game system may evaluate the displayed symbols for winning combinations after the gaming system initially generated the symbols and before the gaming system allows the symbols to interact with other symbols. The gaming system may alternatively evaluate the displayed symbols at other predetermined intervals during a play of the game.

FIG. 4D illustrates one implementation gaming system executing an evaluation of the displayed symbol combinations for winning symbol combinations. As noted above, the player may have wagered on one or more pay lines, which will then be evaluated for winning symbol combinations. Any suitable number of pay lines may be used to evaluate winning symbol combinations. While FIG. 4D shows two pay lines for evaluation, other figures in the disclosure illustrate some of the many alternative pay line evaluations that are possible. Not all pay line alternatives are illustrated in the figures.

In the implementation illustrated in FIG. 4D, the gaming system evaluated one winning pay line across a horizontal direction of symbol display areas including symbol display areas 410a, 410b, 410c, 410d, and 410e. In this implementation, five orange symbols across a pay line results in a winning symbol combination. While only three orange symbols 420b, 420d, and 420e are present across the first row of reels 402a-402e, the Flipside Frenzy symbols take on the characteristics of the orange symbols 420b, 420d, and 420e. Thus, symbols 410a, 410b, 410c, 410d, and 410e would be evaluated as all orange symbols for purposes of the gaming system determining winning symbol combinations. The winning pay line is illustrated as pay line 445 in FIG. 4D across the winning row of reels 402a-402e.

In the implementation illustrated in FIG. 4D, the gaming system also evaluated another winning pay line across another direction of the symbol display areas including symbol display areas 410k, 410g, 410c, 410i, and 410o. In this implementation, five cherry symbols across a pay line results in a winning symbol combination. While only two cherry symbols 420g and 420o are present across pay line 450, the Flipside Frenzy symbols for this pay line take on the characteristics of the cherry symbols 420g and 420o. Thus, symbols 420k, 420g, 420c, 420i, and 420o would be evaluated as all cherry symbols for purposes of the gaming system determining winning symbol combinations. The winning pay line is illustrated as pay line 450 in FIG. 4D across the winning row of reels 402a-402e.

As previously noted, in some implementations, the gaming system evaluates symbol combinations across reels 402a-402e for winning symbol combinations without evaluating symbols displayed in the non-interacting reel 402f.

Based on the winning symbol combination along the pay lines 445 and 450, the gaming system awards the appropriate number of credits to the player and updates the player's credit meter to reflect the winnings. The gaming system may display the number of winning credits and may display the player's total credit balance in a display of the gaming system.

The player may continue the gaming session by playing another game. That is, the player may place a wager and start a new play of the game as noted above. However, continued game play is dependent on the number of credits the player has in the player's credit balance. The player may also choose to cash out. In such an instance, the gaming system provides the player a value based on the player's credit balance using any of the value items discussed above (bills, coins, vouchers, etc.)

From FIGS. 4B-4D, it should be noted that prior to the addition of the Flipside Frenzy symbols 420f1 and 420a1, only one symbol combination was present on any pay lines that would have formed a winning symbol combination from the initially generated symbols on reels 402a-402e (as illustrated in FIG. 4B). However, the game resulted in an additional winning symbol combination for the player due to the interacting symbol 420p and the appearance of Flipside Frenzy symbol in the associated reel 402a. Interacting symbol 420p and the Flipside Frenzy symbol on reel 402a interacted to change the other visible symbols on reel 402a and improve the player's winning outcome.

It should be appreciated that in some implementations, the gaming system may be configured to evaluate the winning symbol combinations before, during, or after the interacting symbols interact with other displayed symbols. In some implementations, the gaming system may not change generated symbols due to the interacting symbols. In one example implementation, if the gaming system determines that changing the generated symbols would result in an equal or worse outcome than the outcome from the initially generated symbols, the gaming system may not change the generated symbols. For example, if the gaming system determines that changing the other symbols to Flipside Frenzy symbols (or executing other game functions based on other symbol interactions) would result in an equal or worse outcome than the outcome from the initially generated and displayed symbols, the gaming system may not cause the other symbols to change to Flipside Frenzy symbols as discussed above. In some implementations, the gaming system may prevent the other symbols from being altered. In other implementations, the gaming system may alter the other symbols to Flipside Frenzy symbols, but then revert the altered symbols to the originally generated symbols when the originally generated symbols would produce a better winning combination of symbols. In yet other implementations, the gaming system may enable the player to select either the initially generated and displayed symbol combination or the displayed symbol combination altered based on the interacting symbols. In such an implementation, the gaming system would evaluate the player selected displayed symbol combination for purposes of determining winning symbol combinations and credit awards. In one such implementation, the gaming system enables the player to make the selection prior to displaying the altered symbol combinations.

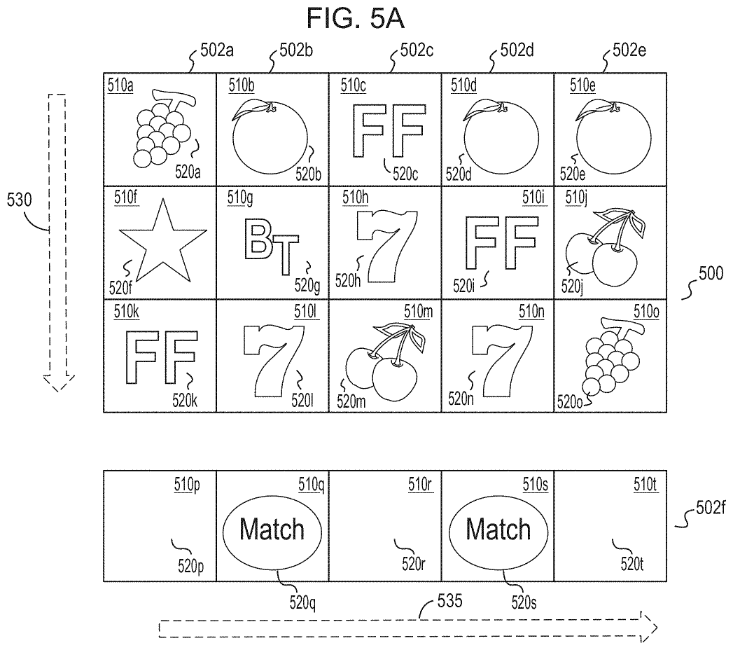

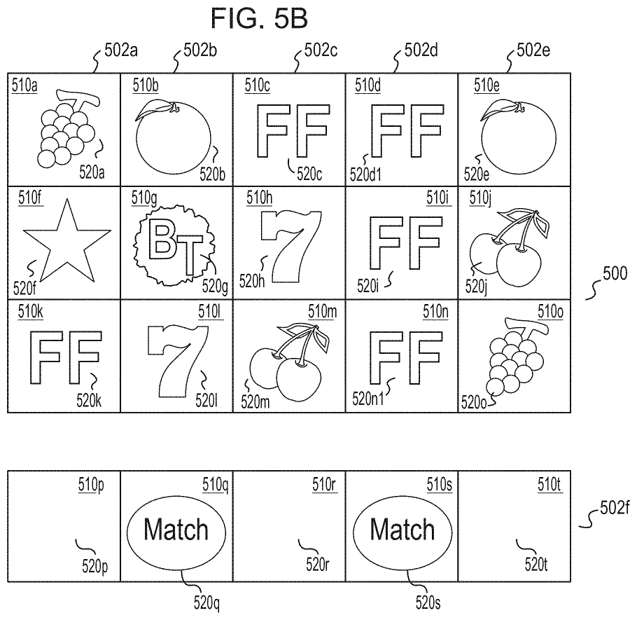

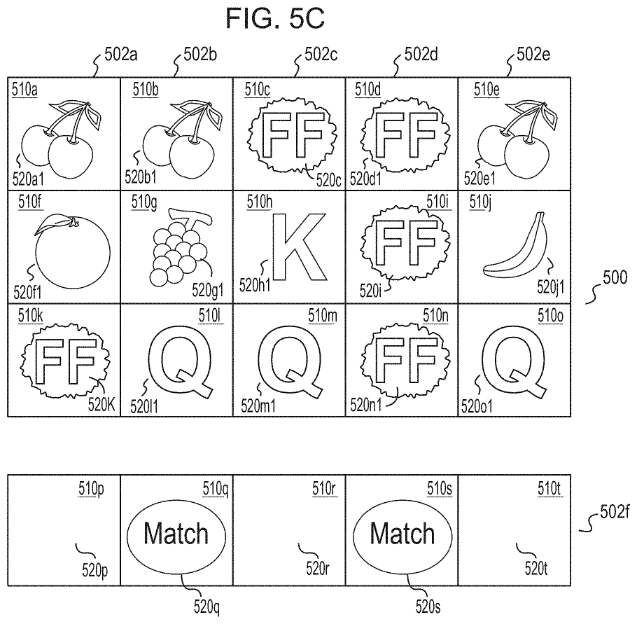

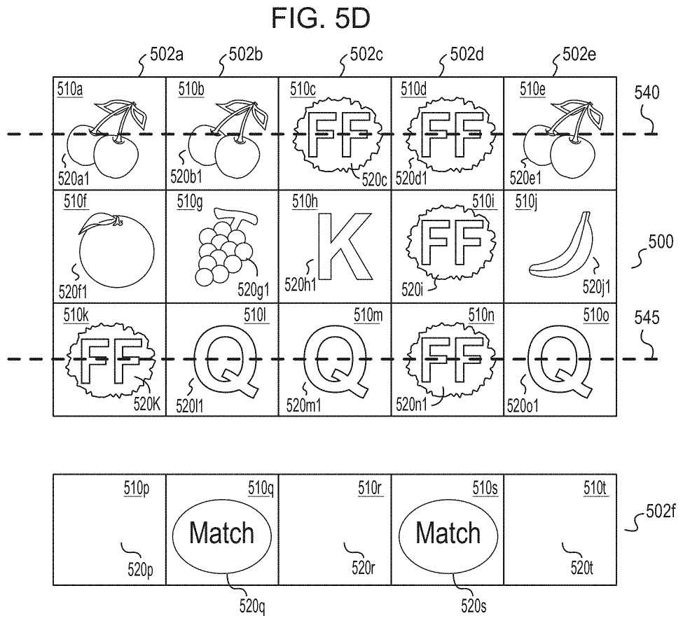

FIGS. 5A, 5B, 5C, and 5D illustrate screen shots of one implementation of a gaming system having a non-interacting reel and a plurality of interacting symbols. In some implementations, the gaming system will generate a plurality of interacting symbols for some or each play of a game. For example, the gaming system may generate a plurality of interacting symbols if the player is in a free spin game or if the player has entered a bonus game. In other implementations, the gaming system may generate a plurality of interacting symbols in a base game.

In FIG. 5A the player has wagered on a play of a base game and the gaming system executed the game in a manner similar to the process discussed in connection with FIGS. 4A-4D. As illustrated in FIG. 5A, the gaming system shows a display of a plurality of symbols from a first set symbols on reels 502a-502e and a second set of symbols on reel 502f. The gaming system randomly generated the symbols and displayed the symbols as previously described. Stopped reels 502a-502e contains symbols 520a-520o in symbol display areas 510a-510o, respectively. As also illustrated in FIG. 5A, stopped non-interacting reel 502f displays a plurality of interacting symbols 520p-520t in symbol display areas 510p-510t.

As illustrated in FIG. 5A, the gaming system randomly generated and displayed symbols 520a, 520f, and 520k in symbol display area 510a, 510f, and 510k for reel 502a. The gaming system also randomly generated and displayed symbols 520b, 520g, and 520l in symbol display areas 510b, 510g, and 510l for reel 502b; symbols 520c, 520h, and 520m in symbol display areas 510c, 510h, and 510m for reel 502c; symbols 520d, 520i, and 520n in symbol display area 510d, 510i, and 510n for reel 502d; and symbols 520e, 520j, and 520o in symbol display area 510e, 510j, and 510o for reel 502e. The gaming system further randomly generated and displayed symbols 520p, 520q, 520r, 520s, and 520t in symbol display area 510p, 510q, 510r, 510s, and 510t for reel 502f.

As also illustrated in FIG. 5A, the gaming system generated and displayed Flipside Frenzy symbols (520k, 520c, 520i) among other symbols in reels 502a, 502c, and 502d. The gaming system also generated and displayed a Bonus Trigger (BT) symbol 520g among other symbols in reel 502c. The gaming system further generated and displayed interacting symbols 520q and 520s for reel 502f. It should be appreciated that the displayed symbol combinations are merely for explanatory purposes and the gaming system may randomly generate any suitable combination of symbols based on defined symbol sets as previously discussed.

In one implementation of FIG. 5B, the gaming system performs an evaluation of the generated symbols on reels 502a-502f and determines whether to execute certain game functions based in part on interactions between the displayed symbols. In one implementation, the gaming system determines whether any interacting symbols were generated and displayed in reel 502f. In the illustrated implementation of FIG. 5B, the gaming system determines that Match symbols, one type of interacting symbol, were generated and displayed in positions 510q and 510s of reel 502f. The gaming system may then determine which reel or column of symbols is associated with each of the interacting symbols 520q and 520s (or symbol display areas 510q and 510s). As noted above, the association between the interacting symbol (or symbol display area) may determine which displayed symbols on which reels the gaming system will evaluate to determine what interactions (if any) the gaming system will execute.

In the implementation illustrated in FIG. 5B, the gaming system determines that interacting symbol 520q is associated with reel 502b and interacting symbol 520s is associated with reel 502d. Based at least in part on this determination, the gaming system determines if any of the symbols 520b, 520g, and 520l interacts with the interacting symbol 520q. The gaming system may also determine if any of the symbols 520d, 520i, and 520n interacts with the interacting symbol 520s. The forgoing determinations can be made in any order.

In one implementation, the gaming system determines (such as using processor 202) that the reel 502d includes a Flipside Frenzy symbol 520i and also determines that a Flipside Frenzy symbol 520i interacts with the interacting symbol 520s. In this implementation, the Flipside Frenzy symbol interacts with the interacting symbol 520s to cause the gaming system to change the behavior of symbols around the Flipside Frenzy symbols.

In one implementation, the gaming system may be specially programmed to cause symbol 520d and 520n of reel 502d in FIG. 5B to convert into Flipside Frenzy symbols because the Flipside Frenzy symbol 520i appeared in the reel 502d which is associated with interacting symbol 520s (or symbol display area 510s). In one implementation, the Flipside Frenzy symbol may interact with the match symbol 520s to cause the Flipside Frenzy symbol to overwrite or replace symbols 520d and 520n. On the other hand, as shown in FIG. 5B, while Flipside Frenzy symbols are also visibly displayed as 520c and 520k, if the Flipside Frenzy symbol is not in a column or reel associated with a generated match symbol in reel 502f (symbol display areas 510p and 510r have blank symbols), the gaming system may determine not to change symbols on reels 502a and 502c into Flipside Frenzy symbols.

In one implementation, the gaming system also determines (such as using processor 202) that the reel 502b includes a BT symbol 520g and also determines that a BT symbol 520g interacts with the interacting symbol 520q. In this implementation, the Flipside Frenzy symbol interacts with the interacting symbol 520q to cause the gaming system to start a bonus game. As illustrated in FIG. 5B, the gaming system may highlight the BT symbol 520g in some manner to further illustrate the interaction between the interacting symbol 520q and BT symbol 520g to the player. In one implementation, where Flipside Frenzy symbols are present, the interaction between the interacting symbol 520q and BT symbol 520g may also cause any displayed Flipside Frenzy symbols to become “sticky” symbols in the bonus game. That is, in the bonus game, displayed Flipside Frenzy symbols may remain in their existing symbol display areas for the bonus game while the gaming system generates new symbols in the other symbol positions on reels 502a-502e.

It should be appreciated that in some implementations, the gaming system may evaluate the symbol combinations in the base game for winning symbol combinations before proceeding to the bonus game. If winning symbol combinations are created in the base game, the gaming system may award the player the appropriate credits for the base game before the bonus game starts. In some implementations, the gaming system may wait until the conclusion of the bonus game before awarding any credits for the base game.

As illustrated in FIG. 5C, the gaming system started the bonus game. In some implementations, the gaming system automatically starts the bonus game. In other implementations, the gaming system waits for the player to initiate the bonus game using a suitable player input. In the implementation of FIG. 5C, the bonus game includes a free spin of the reels. FIG. 5C illustrates the gaming system displaying of a plurality of symbols from a first set symbols on reels 502a-502e. In this implementation, the symbols on reel 502f do not change. However, it should be appreciated that in some implementations the gaming system can generate new symbols from the second set of symbols for reel 502f and perform further symbol interaction evaluations in the bonus game. In other implementations, the gaming system may remove reel 502f from the display and not process symbol interactions during the bonus game.

Returning now to FIG. 5C, the gaming system randomly generated at least some new symbols on reels 502a-502e, as previously described. Thus, stopped reels 502a-502e now displays some new symbols and some symbols generated in the base game in symbol display areas 510a-510o, respectively. Specifically, as illustrated in FIG. 5A, the gaming system randomly generated and displayed new symbols 520a1 and 520f1 in symbol display area 510a and 510f for reel 502a. The gaming system also randomly generated and displayed new symbols 520b1, 520g1, and 52011 in symbol display areas 510b, 510g, and 510l for reel 502b; symbols 520h1 and 520m1 in symbol display areas 510h and 510m for reel 502c; and symbols 520e1, 520j1, and 520o1 in symbol display area 510e, 510j, and 510o for reel 502e.

As noted above, in one implementation, certain symbols from the base game were made “sticky” for purposes of the bonus game. That is, the gaming system did not randomly generate new symbols to replace the Flipside Frenzy symbols 520k, 520c, 520d, 520i, and 520n. Rather, the gaming system allowed the Flipside Frenzy symbols to remain displayed for the bonus game, providing a chance for the player to use the many Flipside Frenzy symbols for increased chances to win in the bonus game. As also illustrated in FIG. 5C, the gaming system may highlight the symbols 520k, 520c, 520d, 520i, and 520n to let the player know that the symbol interactions turned these symbols “sticky” for the bonus game. It should be appreciated that other suitable symbols can be made “sticky” for bonus game, free spins, or other suitable games.

In FIG. 5D, the player has completed the free spin in the bonus game. The gaming device then evaluates the displayed symbol combinations for winning symbol combinations in the bonus game. FIG. 5D illustrates one implementation of the gaming system executing an evaluation of the displayed symbol combinations for winning symbol combinations. As noted above, the player may have wagered on one or more pay lines, which the gaming system can evaluate for winning symbol combinations. In the implementation illustrated in FIG. 5D, the player wagered on at least two different pay lines 540 and 545. As noted above, the gaming system can be configured to enable a player to wager on any suitable number of pay lines and thus evaluate any suitable number of winning symbol combinations along the pay lines.

In the implementation illustrated in FIG. 5D, the gaming system evaluated pay line 540 that combines symbols 520a1, 520b1, 520c, 510d1, and 520e1 for a winning symbol combination of five cherries. As noted above, the Flipside Frenzy symbols mimics other symbols. In the illustrated implementation, the Flipside Frenzy symbols 520c and 520d1 mimic the cherry symbols 520a1, 520b1, and 520e1 to produce the winning combination along pay line 540. The gaming system evaluated pay line 545 that combines symbols 510k, 510l1, 510m1, 510n1, and 510o1 for a winning symbol combination of five queens. For this pay line evaluation, the Flipside Frenzy symbols mimicked the queen symbols.

Based on the winning symbol combinations along the pay lines 540 and 545 the gaming system awards the appropriate number of credits to the player and updates the player's credit meter to reflect the winnings. The gaming system may display the number of winning credits and may display the player's total credit balance in a display of the gaming system. The gaming system may return to the base game if additional base game features can be executed.

The player may continue the gaming session by playing another game as discussed above. However, continued game play is dependent upon the number of credits the player has in the player's credit balance. If the player does not retain enough credits in the player's credit balance, the game system may enable the player to insert additional value to replenish the player's credit balance. The player may also choose to cash out. In such an instance, the gaming system provides the player a value based on the player's credit balance using any of the value items discussed above (bills, coins, vouchers, etc.)

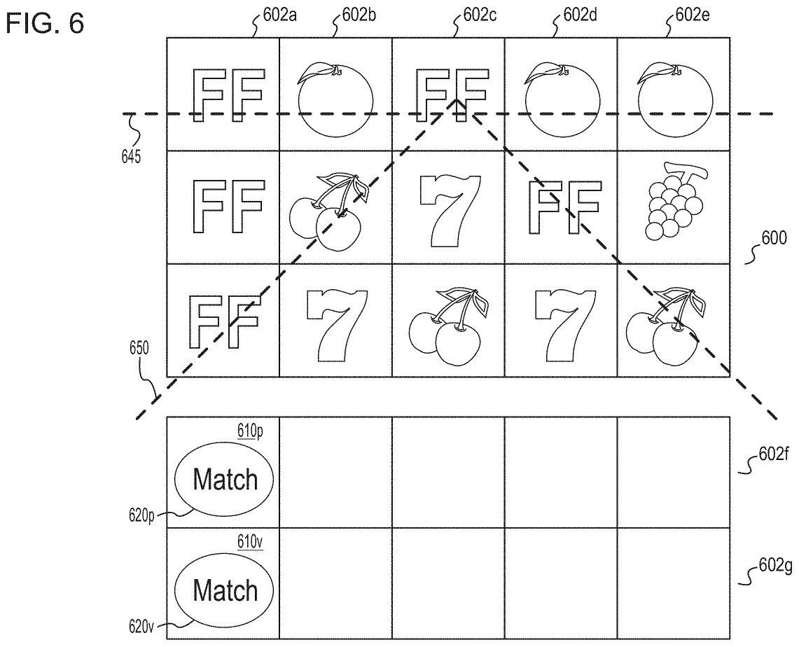

The gaming system may also include two or more non-interacting reels. In one such example with two non-interacting reels, the non-interacting reels are displayed as stacked on top of each other. However, the two non-interacting reels may include any suitable amount of separation between the reels. In one such implementation, the gaming system may evaluate the symbols displayed on the first set of reels for interactions with interacting symbols if an interacting symbol is generated and displayed for each non-interacting reel. In one implementation, both interacting symbols must appear in a symbol display area that is associated with the same reel of the first set of reels. For example, a first interacting symbol is displayed and is associated with a first reel and a second interacting symbol is displayed in the other non-interacting reel that is also associated with the first reel. FIG. 6 illustrates one such implementation.

FIG. 6 illustrates a screen shot 600 of one implementation of a gaming system having a plurality of non-interacting reels and a plurality of interacting symbols. For purposes of brevity, a play of a game illustrated in FIG. 6 is similar to a play of the games described above and will not be described again in full. However, in FIG. 6, because the gaming system uses two non-interacting reels 602f and 602g during a play of a game, differences in the game play will be further discussed.

For example, in FIG. 6, after the gaming system randomly generates symbols for reels 602a-602g, the gaming system may determine whether interacting symbols appear in both reel 602f and 602g. If the gaming system determines that interacting symbols do not appear in both reel 602f and 602g, the gaming system may skip any further processing of the non-interacting reels and proceed to evaluating the generated symbols in reels 602a-602e for winning symbol combinations, as previously discussed.

If the gaming system determines that interacting symbols appear in both reel 602f and 602g, the gaming system may determine if both interacting symbols are associated with the same reel. In the implementation illustrated in FIG. 6, both symbols 620p and 620v are associated with reel 602a. In one such implementation, the gaming system may then determine whether both interacting symbols 620p and 620v are the same interacting symbol. In one implementation, both interacting symbols must be the same before the gaming device will determine if any symbols in the associated reel (reel 602a in this example) interact with the interacting symbols 620p and 620v. However, it should be appreciated that in other implementations, the interacting symbols do not need to be the same. In some implementations, the interacting symbols must be different before the gaming system proceeds to determine whether such interacting symbols interact with any of the symbols in reel 602a. In some such implementations with different interacting symbols, it should be appreciated that the gaming system may execute different interactions in during a play of a game based on the different interacting symbols.

Returning to FIG. 6, if the gaming system determines that both interacting symbols 620p and 620v are the same, the gaming system then determines whether such interacting symbols interact with any of the symbols in reel 602a. The gaming system may execute the interactions and game functions if any symbol interactions are determined, as previously described with respect to the other figures.

In the implementation illustrated in FIG. 6, the interacting symbols 620p and 620v caused reel 602a to fill with Flipside Frenzy symbols. Due to the expansion of the Flipside Frenzy symbols, the gaming system determined that multiple winning symbol combinations were displayed as shown by pay lines 645 and 650. The gaming system may complete the game as previously described with respect to the other figures.

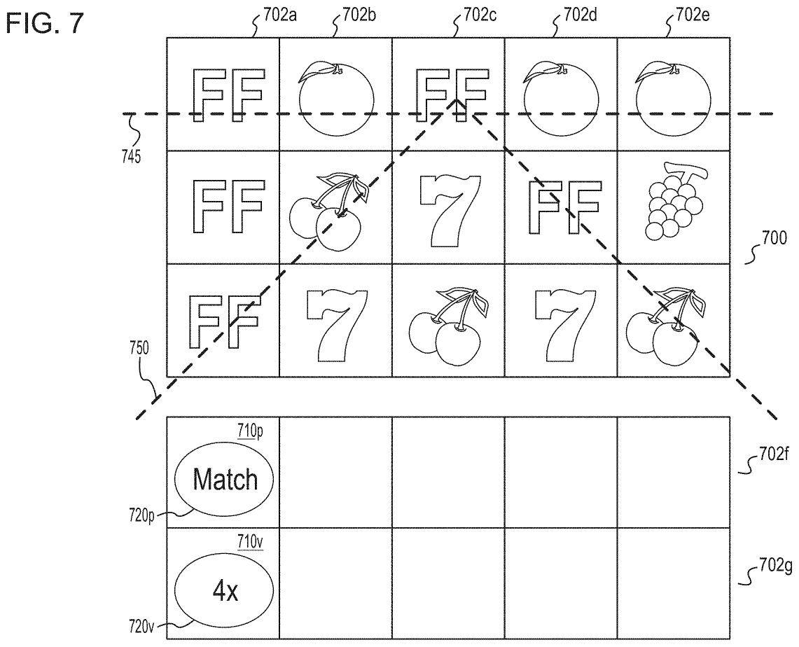

In another implementation with multiple non-interacting reels, a first interacting symbol may appear in a symbol display area of one non-interacting reel to cause symbols in a reel to change their behavior while a second interacting symbol may appear in another non-interacting reel to cause the gaming system to perform a payout multiplier on any winning outcomes. FIG. 7 illustrates one such implementation.

FIG. 7 illustrates a screen shot 700 of one implementation of a gaming system having a plurality of non-interacting reels and a plurality of interacting symbols. For purposes of brevity, a play of a game illustrated in FIG. 7 is similar to a play of the games described above and will not be described again in full. However, in FIG. 7, because the gaming system uses two non-interacting reels 702f and 702g during a play of a game, differences in the game play will be further discussed.

For example, in FIG. 7, after the gaming system randomly generates symbols for reels 702a-702g, the gaming system may determine whether interacting symbols appear in both reel 702f and 702g. If the gaming system determines that interacting symbols do not appear in both reel 702f and 702g, the gaming system may skip any further processing of the non-interacting reels and proceed to evaluating the generated symbols in reels 702a-702e for winning symbol combinations as previously discussed. Is should be appreciated that in some implementations, if an interacting symbol is displayed in just one non-interacting reel, then the gaming system may proceed with the symbol interaction evaluations as discussed above.

If the gaming system determines that interacting symbols appear in both reel 702f and 702g, the gaming system may determine if both interacting symbols are associated with the same reel. In the implementation illustrated in FIG. 7, both symbols 720p and 720v are associated with reel 702a. In one such implementation, the gaming system may then determine whether both interacting symbols 720p and 720v are the same interacting symbol. In this implementation, both interacting symbols do not need to be the same before the gaming device will determine if any symbols in the associated reel (reel 702a in this example) interact with the interacting symbols 720p and 720v.

In the implementation of FIG. 7, the gaming system determines that the interacting symbols 720p and 720v are different. The gaming system then determines what interactions, if any, each of the interacting symbols may have with the symbols displayed in an associated reel. In this implementation, interacting symbols 720p and 720v are both associated with reel 702a, thus the gaming system determines whether such interacting symbols interact with any of the symbols in reel 702a. The gaming system may execute the interactions and game functions if any symbol interactions are determined, as previously described with respect to the other figures.

In the implementation of FIG. 7, because the interacting symbols are different, the gaming system may execute different interactions during a play of a game based on the different interacting symbols. For example, the Match symbol 720p may interact with a symbol in reel 702a to change other symbols in the reel 702a. In some implementations, payout multiplier 720v interacts with a symbol in reel 702a to provide a payout multiplier. However, in some implementations, it should be appreciated that a payout multiplier may not require a symbol in reel 702a to interact with. That is, in some implementations, if the gaming system executed at least one other interaction (such as the interaction with interacting symbol 720p), when the payout multiplier is displayed, the gaming system will multiply any determined awards by the multiplier. In yet other implementations, if the payout multiplier is displayed on any non-interacting reel, the gaming system may multiply any determined awards by the multiplier regardless of interactions with the interacting multiplier symbol or any other symbol interactions.

In the implementation illustrated in FIG. 7, the interacting symbol 720p caused reel 702a to fill with Flipside Frenzy symbols. Due to the replacement of other symbols on reel 702a with Flipside Frenzy symbols, the gaming system determined that multiple winning symbol combinations were displayed as shown by pay lines 745 and 750. In this implementation, due to the interaction between the interacting symbol 720v and a symbol on reel 702a, the gaming system also multiplied any determined award by four. The gaming system may complete the game as previously described with respect to the other figures.

In some implementations, the symbol interactions are performed in a particular order. For example, if a particular order of execution of a plurality of symbol interactions provided a player with a better winning combination of symbols, the gaming system may execute the plurality of symbol interactions in the particular order. However, in some implementations, the particular order of execution of a plurality of symbol interactions does not matter and the gaming system may execute the symbol interactions in any suitable order.

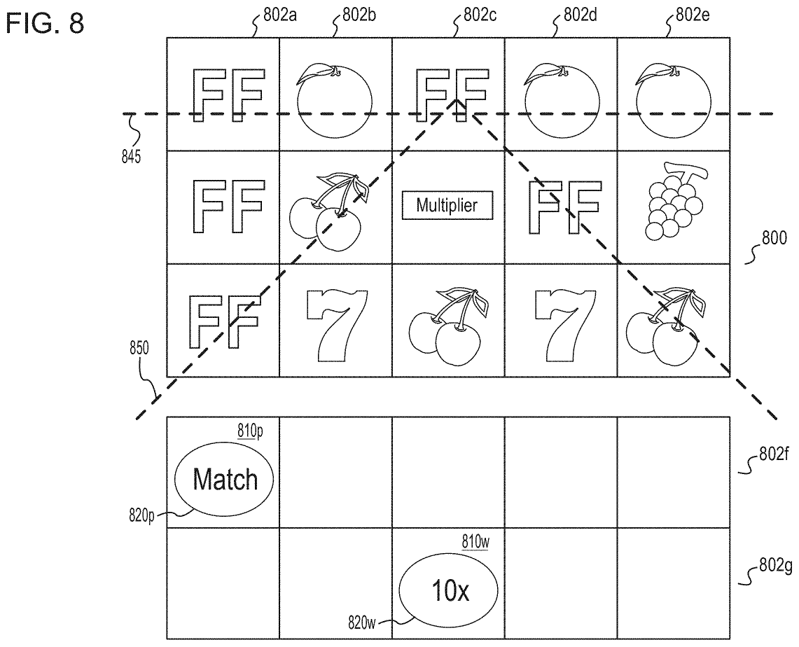

In another implementation with multiple non-interacting reels, interacting symbols may be displayed in different non-interacting reels and be associated with different reels. In these implementations, the gaming system may still execute symbol interactions based on each of the displayed interacting symbols. For example, a first interacting symbol may appear in a symbol display area of one non-interacting reel to cause symbols in certain reels to change their behavior while a second interacting symbol may appear in another non-interacting reel to cause the gaming system to perform a payout multiplier on any winning outcomes. FIG. 8 illustrates one such implementation.

FIG. 8 illustrates a screen shot 800 of one implementation of a gaming system having a plurality of non-interacting reels and a plurality of interacting symbols. For purposes of brevity, a play of a game illustrated in FIG. 8 is similar to a play of the games described above and will not be described again in full. However, in FIG. 8, because the gaming system uses two non-interacting reels 802f and 802g during a play of a game, differences in the game play will be further discussed.

For example, in FIG. 8, after the gaming system randomly generates symbols for reels 802a-802g, the gaming system may determine whether interacting symbols appear in both reels 802f and 802g. If the gaming system determines that interacting symbols do not appear in both reels 802f and 802g, the gaming system may skip any further processing of the non-interacting reels and proceed to evaluating the generated symbols in reels 802a-802e for winning symbol combinations, as previously discussed. It should be appreciated that in some implementations, if an interacting symbol is displayed in just one non-interacting reel, then the gaming system may proceed with the symbol interaction evaluations as discussed above.

If the gaming system determines that interacting symbols appear in both reels 802f and 802g, the gaming system may determine if both interacting symbols are associated with the same reel. In the implementation illustrated in FIG. 8, interacting symbols 820p and 820w are not associated with the same reel. Interacting symbol 820p is associated with reel 802a and interacting symbol 820w is associated with reel 802c. In this implementation, the interacting symbols do not need to be associated with the same reel for the gaming system to execute the symbol interactions.

It should be appreciated that while the association of an interacting symbol to a reel has generally been illustrated as based on an interacting symbol being vertically aligned with a reel, the gaming system may randomly generate an association between an interacting symbol and any particular reel. In such alternative implementations, the gaming system may provide at least one other visual clue to allow a player to understand which interacting symbol is associated with which reel.

Returning to the implementation of FIG. 8, the gaming system determines that both interacting symbols 820p and 820w are different. The gaming system then determines what interactions, if any, each of the interacting symbols may have with the symbols in an associated reel. In this implementation, interacting symbols 820p is associated with reel 802a, thus the gaming system determines whether such interacting symbol interacts with any of the symbols in reel 802a. In this implementation, interacting symbol 820w is associated with reel 802c, thus the gaming system determines whether such interacting symbol interacts with any of the symbols in reel 802c. The gaming system may execute the interactions and game functions if any symbol interactions are determined as previously described with respect to the other figures.

In the implementation of FIG. 8, because the interacting symbols are different the gaming system may execute different interactions during a play of a game based on the different interacting symbols. For example, the Match symbol 820p may interact with a symbol in reel 802a to change other symbols in the reel 802a. In some implementations, payout multiplier 820w interacts with a symbol in reel 802c to provide a payout multiplier. However, in some implementations, it should be appreciated that a payout multiplier may not require a symbol in reel 802c to interact with before the gaming system provides the player the payout multiplier. That is, in some implementations, if the gaming system executed at least one other interaction (such as an interaction with interacting symbol 820p), when the payout multiplier is displayed, the gaming system will multiply any determined awards by the multiplier. In yet other implementations, if the payout multiplier is displayed on any non-interacting reel, the gaming system may multiply any determined awards by the multiplier regardless of interactions with the interacting multiplier symbol or any other interacting symbol interactions.

In the implementation illustrated in FIG. 8, the interacting symbols 820p caused reel 802a to fill with Flipside Frenzy symbols. Due to the replacement of other symbols on reel 802a with Flipside Frenzy symbols, the gaming system determined that multiple winning symbol combinations were displayed as shown by pay lines 845 and 850. In this implementation, due to the interaction between the interacting symbol 820w and a multiplier symbol on reel 802c, the gaming system also multiplied any determined award by 10 due to the symbol interaction. The gaming system may complete the game as previously described with respect to the other figures.

It should be appreciated that non-interacting reels with interacting symbols increase a game player's anticipation for the possible game outcomes. Even if no winning symbol combinations are determined after an initial generation of symbols or after an initial spin of a set of gaming reels, associating interacting symbols with a reel to produce symbol interactions can dramatically alter the winning symbol combinations formed after the initial symbols are displayed.

By identifying a column of displayed symbols and then altering symbols in a column based upon the interaction characteristics of symbols, the gaming system described herein creates a new level of game element interactions within a game. This also adds a new level of anticipation and excitement for game players.

The non-interacting reels also increase the amount of screen “real estate” that a game uses on a screen. One problem that game designers face is that the use of increasing larger displays in gaming devices creates a lot of unused space. The unused space can be distracting to players and may cause players to find a gaming device less appealing. Some game designers have simply added more reels and symbols, which are all used to determine winning symbol combinations. Adding more reels and symbols that are used in determining winning symbol combinations leads to games with lower volatility by mathematical necessity. By adding non-interacting reels, a game designer can minimize the volatility issues while also filling out unused screen space and provide additional levels of anticipation and excitement for game players. Thus, adding the non-interacting reels to a gaming system further provides a technical solution to the technical problem of unused display “real estate” created by larger displays without negatively impacting volatility of a game.

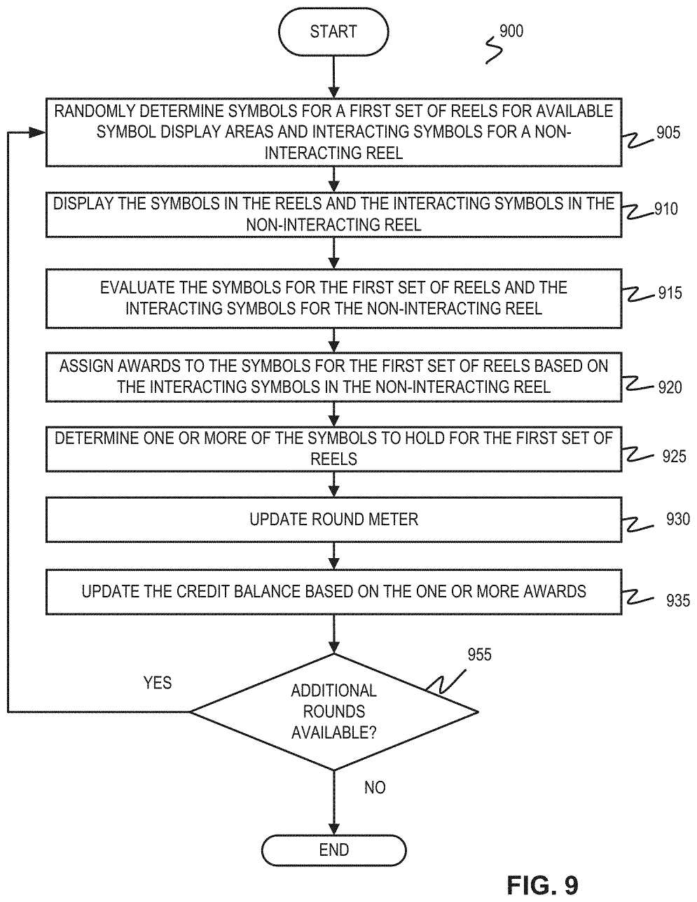

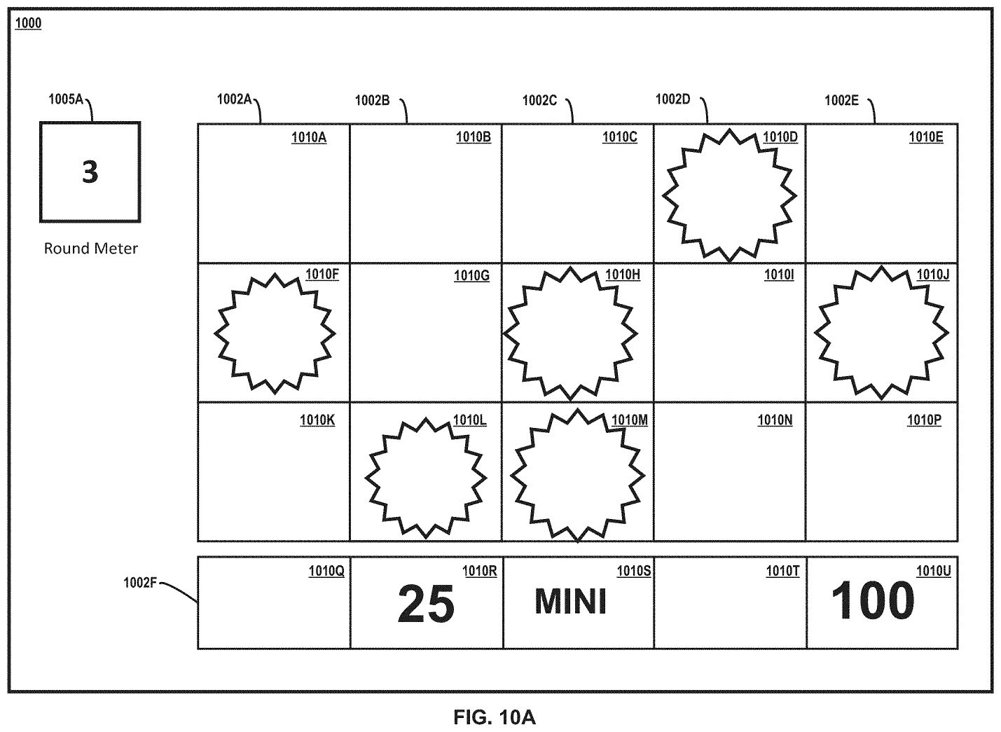

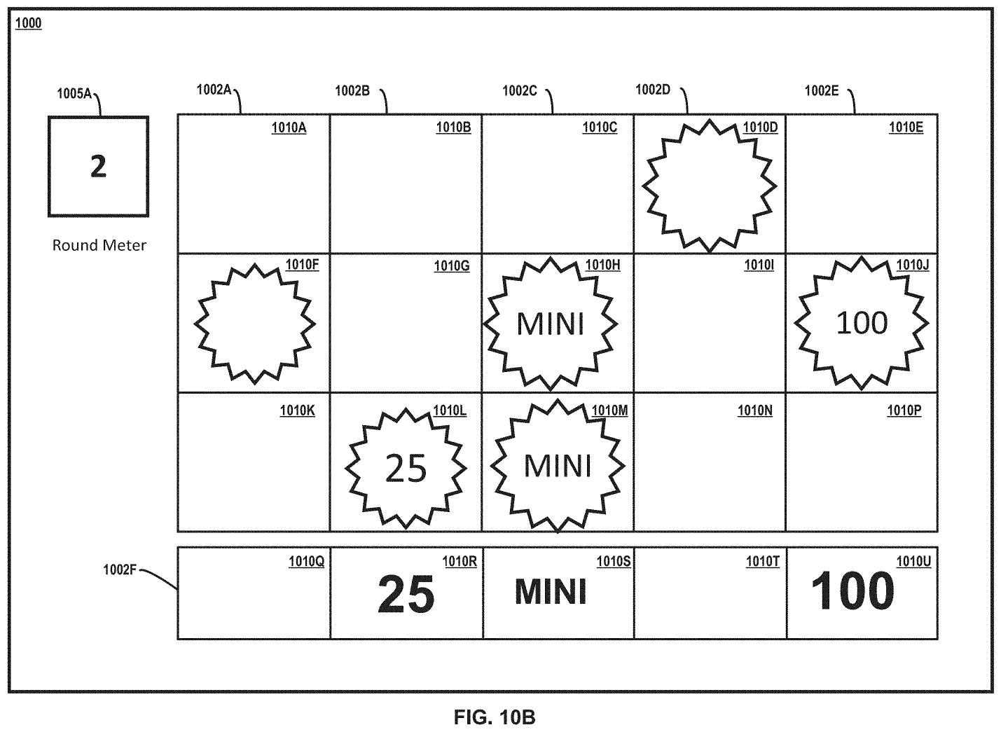

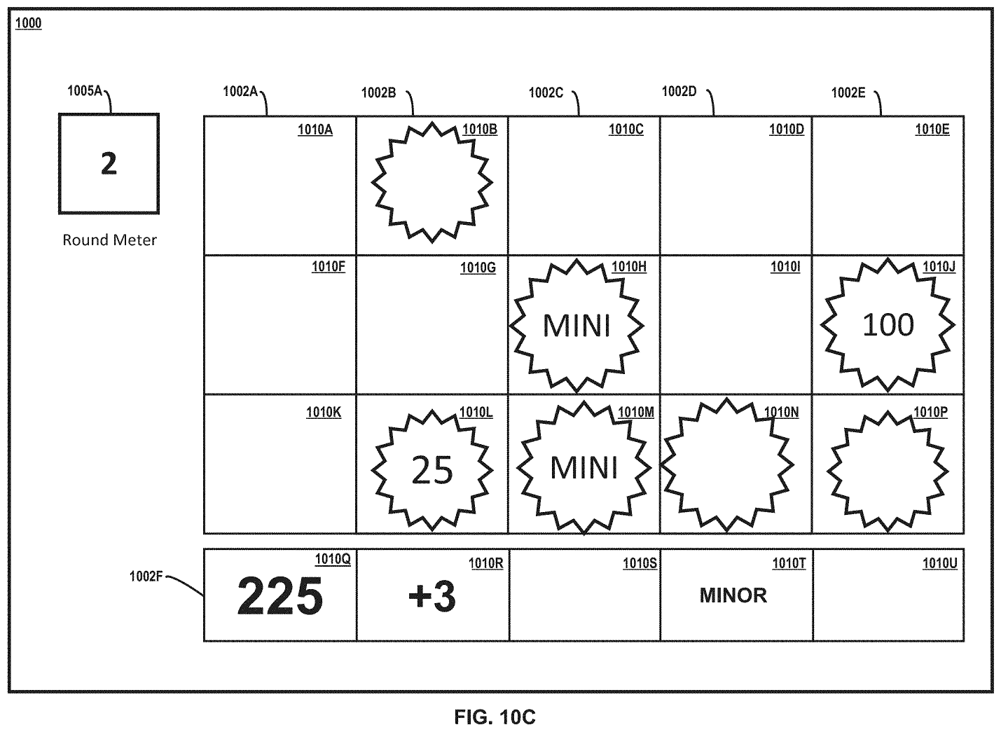

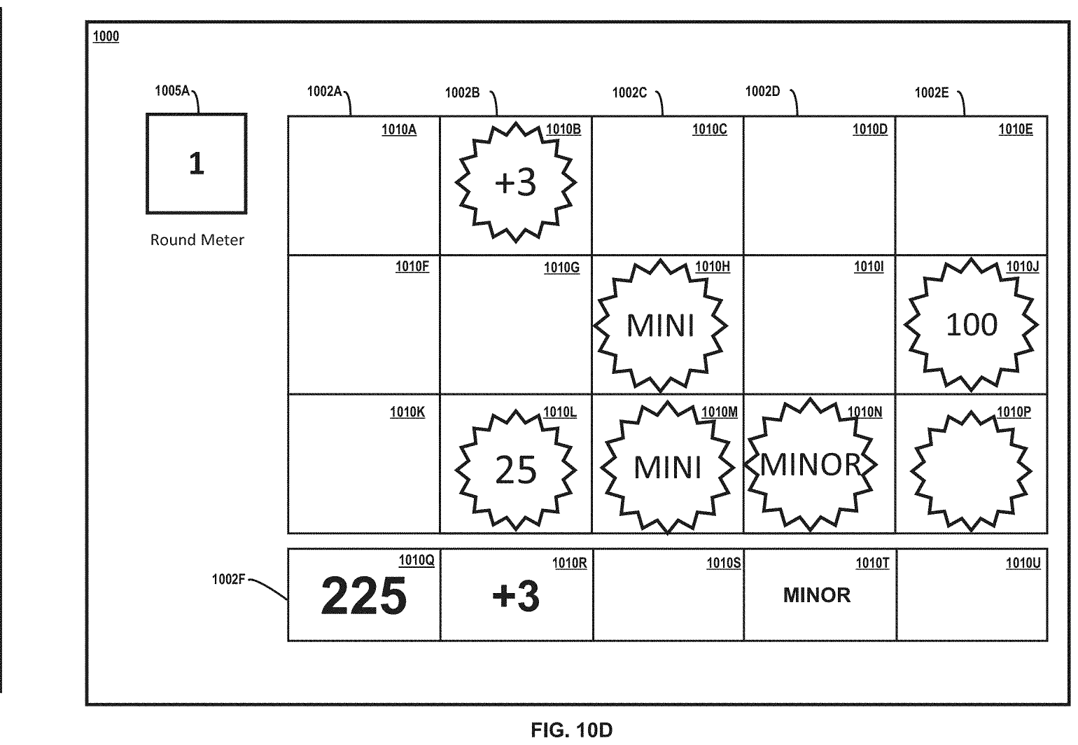

Additional alternative implementations of using non-interacting reels are discussed in connection with FIGS. 9 and 10A-10D. In some alternative implementations, as is discussed in FIGS. 9 and 10A-10D, the one or more non-interacting reels can be used in a hold and respin feature or bonus game. In some implementations, the hold and respin game includes randomly generated and displayed symbols on a plurality of reels that can be held for one or more rounds or plays of a game while other randomly generated and displayed symbols can be removed and replaced with additionally randomly generated and displayed symbols. In some implementations, the gaming system may include a first set of reels where symbols can be held and/or re-spun and one or more non-interacting reels. In some implementations, the non-interacting reels can include interacting symbols that interact with one or more displayed symbols on the first set of reels. In some implementations, the interaction may cause the gaming system to assign awards or award values to the one or more displayed symbols on the first set of reels, where the award or award values are displayed on interacting symbols.

In some implementations, the non-interacting reels can be displayed above or below the first set of reels. In some implementations, the non-interacting reels can be displayed in other orientations with respect to the first set of reels. In some implementations, the non-interacting reels can be one or more vertically aligned reels.

In some implementations, operation 900 details one or more aspects of a hold and respin feature or bonus game. In some implementations, for example, the hold and respin game can be triggered on or before block 365 in FIG. 3B. In some implementations, the hold and respin game can be a stand-alone game that is played separate from the game described in FIGS. 3A and 3B. In some implementations, the hold and respin game can be used with other suitable games and gaming systems and triggered at any suitable time. The operation 900 may include more blocks or fewer blocks. In some implementations, the illustrated blocks can be arranged in any suitable order.

In some implementations, when operation 900 has been triggered, the gaming system may randomly determine (e.g., generate, select, etc.) symbols for symbol display areas of a first set of reels as illustrated in block 905. As shown in block 910 of FIG. 9, the gaming system may also display the randomly determined symbols for the first set of reels.

In some implementations, the first set of reels may include blank symbols and special symbols. In some implementations, the special symbols are not associated with awards. In some implementations, the special symbols are configured to interact with interacting symbols to receive attributes of interacting symbols displayed in a non-interacting reel. However, it should be appreciated that the reels for the first set of symbols can include any suitable symbols as discussed above with the other figures. For example, in some implementations, the gaming system may generate and display blank symbols and special symbols (e.g., star symbols) for reels 1002A, 1002B, 1002C, 1002D, and 1002E as illustrated in the gaming screen 1000 of FIG. 10A. In FIG. 10A, the gaming system generated blank symbols in symbol display areas 1010A, 1010B, 1010C, 1010E, 1010G, 1010I, 1010K, 1010N, and 1010P. The gaming system also generated star symbols in symbol display areas 1010D, 1010F, 1010H, 1010J, 1010L, and 1010M as is shown in FIG. 10A. As noted above, in some implementations, the star symbols are initially not associated with values or awards. However, in some implementations, one or more of the star symbols can be associated with values or awards. It should also be appreciated that the displayed symbols on the first set of reels 1002A-1002E are merely for explanatory purposes and the gaming system can generate and display other suitable symbols for these reels. While FIG. 9 and FIG. 10A-10D are discussed herein as having traditional vertical reels (e.g., reel 1002A having symbol display areas 1010A, 1010F, and 1010K), in some implementations, the gaming system can be configured with individual reels associated with one or more of the symbol display areas. For example, in some implementations, symbol display area 1010A may be associated with a reel that is separately operable from symbol display area 1010F having its own separately operable reel.

Returning to block 905 of FIG. 9, in some implementations, the gaming system may also randomly determine interacting symbols for a non-interacting reel for symbol display areas of the non-interacting reel. In some implementations, the interacting symbols available on a non-interacting reel may include award symbols such as credit awards, jackpot awards, progressive jackpot awards, free rounds awards, free spins awards, free game awards, or other suitable awards. In some implementations, the jackpot and/or progressive jackpot award symbols can be expressed as MINI, MINOR, MAJOR, GRAND, etc. or using some other suitable symbol design. In some implementations, the jackpot and/or progressive jackpot award symbols may be associated with one or more different levels of awards. For example, a MINI jackpot award symbol may be associated with a relatively low value award (e.g., $30 or some other suitable number), a MINOR jackpot award symbol may be associated with a higher value award than the MINI jackpot award symbols (e.g., $100), a MAJOR jackpot award symbol may be associated with a higher value award than the MINI or MINOR jackpot awards (e.g., $1000), etc. In some implementations, the non-interacting reel may include blank symbols as well as any other suitable symbols. In block 910, the gaming system may also display the randomly determined symbols for the non-interacting reel. As illustrated in FIG. 10A, the gaming system generated and displayed blank symbols and award symbols for non-interacting reel 1002F. Specifically, in FIG. 10A, the gaming system generated a blank symbol in symbol display area 1010Q, a 25 credit symbol in symbol display area 1010R, a MINI jackpot symbol in symbol display area 1010S, a blank symbol in symbol display area 1010T, and a 100 credit symbol in symbol display area 1010U. It should be appreciated that the displayed symbols on the non-interacting reel 1002F are merely for explanatory purposes and the gaming system can generate and display other suitable symbols for the non-interacting reel 1002F.

In some implementations, the non-interacting reel 1002F is a horizontally oriented reel with respect to the first set of reels 1002A-1002E. For example, the gaming system may show the non-interacting reel 1002F spin in a direction that is perpendicular to the spin direction of the reels 1002A-1002E. In some implementations, the non-interacting reel 1002F comprises one or more vertically positioned reels. For example, in some implementations, symbol display area 1010Q may represent an individual reel with its own associated symbol set, symbol display area 1010R may represent another individual reel with its own associated symbol set, etc. In some implementations, the first set of reels (e.g., reels 1002A-1002E) may spin and stop in coordination with the non-interacting reels. However, it should be appreciated that the timing of the various reels spinning and stopping can be synchronous or asynchronous with respect to each other.

In some implementations where the gaming system triggers the hold and respin bonus game, the gaming system provides a predetermined quantity of rounds of the bonus game. The rounds can be free rounds or free spins. In some implementations, the rounds may require additional wagers. In some implementations, the predetermined quantity of rounds is 3 rounds; provided however, the gaming system may be configured to provide any suitable quantity of rounds to the player. In some implementations, as shown in FIG. 10A, the gaming system may display a round meter 1005A that is updated as the bonus game is played. The round meter 1005A of FIG. 10A illustrates that three rounds of the bonus game are available.

Turning to block 915 of FIG. 9, in some implementations, the gaming system may evaluate the determined symbols for the first set of reels and the interacting symbols for the non-interacting reel for possible interactions. For example, in some implementations, the gaming system determines whether interacting symbols in the non-interacting reel 1002F interact with displayed symbols of the first set of reels 1002A-1002E as shown in FIG. 10A. In some implementations, the gaming system determines the interaction based on an association between reels 1002A-1002E and one or more symbol display areas of the non-interacting reel 1002F. In some implementations, the gaming system also determines the interaction based on the symbols displayed in the non-interacting reel 1002F and the symbols displayed in associated reels. For example, in some implementations, reel 1002A is associated with symbol display area 1010Q of the non-interacting reel 1002F, reel 1002B is associated with symbol display area 1010R of the non-interacting reel 1002F, reel 1002C is associated with symbol display area 1010S of the non-interacting reel 1002F, reel 1002D is associated with symbol display area 1010T of the non-interacting reel 1002F, and reel 1002E is associated with symbol display area 1010U of the non-interacting reel 1002F. In alternative implementations, the association between particular symbol display areas of the non-interacting reel 1002F and the reels 1002A-1002E of the first set of reels can be arranged in other suitable manners. In some implementations, as part of the evaluation in block 915, the gaming system determines whether symbol display area 1010Q includes an interacting symbol associated with an award. Because symbol display area 1010Q displays a blank symbol, the gaming system determines that no interaction will occur with symbols displayed in reel 1002A. In some implementations, the gaming system does not perform an evaluation of the reel 1002A for symbols because no interaction will occur. The gaming system may similarly determine not to perform an evaluation for symbol display area 1010T and reel 1002D because symbol display area 1010T displays a blank symbol. The gaming system may determine that symbol display areas 1010R, 1010S, and 1010U of the non-interacting reel include interacting symbols. Accordingly, the gaming system may evaluate associated reels 1002B, 1002C, and 1002E for symbols that interact with the interacting symbols in symbol display areas 1010R, 1010S, and 1010U (e.g., due to the symbol display areas 1010R, 1010S, and 1010U being associated with reels 1002B, 1002C, and 1002E).

At block 920 of FIG. 9, the gaming system may assign awards to the displayed symbols for the first set of reels based on the interacting symbols displayed in the non-interacting reel in some implementations. As shown in FIG. 10B, the gaming system assigned a 25 credit award to the star symbol in symbol display area 1010L because of the association between the symbol display area 1010R and the reel 1002B and because the star symbol interacts with the interacting symbol. That is, in some implementations, the gaming system may provide an attribute of an interacting symbol to a star symbol as part of the interaction between such symbols. As also shown in FIG. 10B, the gaming system assigned a MINI jackpot award to the star symbols in symbol display areas 1010H and 1010M because of the association between the symbol display area 1010S and the reel 1002C and because the star symbols interact with the interacting symbol. It should also be appreciated that the gaming system may assign an award from the non-interacting reel 1002F to one or more symbols in a reel as shown in reel 1002C. In some implementations, the gaming system may restrict assigning an award from one interacting reel to more than one symbol in a reel based on the player's wager level. That is, in some implementations, if a player wagered less than a threshold value, the gaming system may restrict the quantity of symbols in reels 1002A-1002E that are assigned award values from an interacting symbol. As further shown in FIG. 10B, the gaming system assigned a 100 credit award to the star symbol in symbol display area 1010J because of the association between the symbol display area 1010U and the reel 1002E and because the star symbol interacts with the interacting symbol. In some implementations, one or more symbols used for reels 1002A-1002E can be configured to not interact with one or more interacting symbols in reel 1002F. For example, one or more symbols used for reel 1002A can be configured to receive an assignment of free spins from an interacting symbol, but not receive an assignment of a credit award from another interacting symbol. In some implementations, certain interacting symbols in reel 1002F can be configured to interact with particular ones of the symbols displayable in reels 1002A-1002E. In some implementations, as is shown in FIGS. 10A-10D, all interacting symbols of reel 1002F may interact with all symbols in reels 1002A-1002E.

At block 925 of FIG. 9, in some implementations, the gaming system may determine one or more of the displayed symbols of the first set of reels to hold for a next round of the play of the game. In some implementations, the gaming system holds displayed symbols on reels 1002A-1002E based on whether such displayed symbols were assigned awards in accordance with block 920. In some implementations, the gaming system holds displayed symbols on reels 1002A-1002E based on whether such displayed symbols were assigned credit awards (e.g., credit values, jackpot awards, progressive jackpot awards), but does not hold displayed symbols that were assigned other awards such as free round or free spin awards. In alternative implementations, the gaming system can be configured to hold any suitable different types of symbols while allowing other suitable symbols to be re-spun and replaced in a subsequent bonus round or free spin. In some implementations, the gaming system does not hold blank symbols. As shown in FIG. 10A, the gaming system may determine that symbols displayed in symbol display area 1010D and 1010F will not be held and the blank symbols will not be held, while the symbols assigned credit awards in symbol display areas 1010H, 1010J, 1010L and 1010M can be held for one or more next rounds of the bonus game. It should be appreciated, that the gaming system may determine which symbols to hold and which symbols can be replaced after block 930, block 935, or some other suitable time.

At block 930 of FIG. 9, the gaming system may update the round meter, such as round meter 1005A of FIG. 10B, to reflect that the gaming system executed one round of the bonus game. At block 935, in some implementations, the gaming system may issue awards assigned to displayed symbols of the first set of reels and update the credit balance based on the one or more awards. For example, the gaming system may add the MINI awards on symbols displayed in symbol display areas 1010H and 1010M, the 100 credit award on the symbol displayed in symbol display area 1010J, and the 25 credit award on the symbol displayed in symbol display area 1010L to the player's credit meter for the bonus game. It should be appreciated, that in some implementations, the gaming system may issue awards associated with displayed symbols on reels 1002A-1002E at some later time during the bonus game (e.g., in one or more subsequent rounds of the bonus game).

At block 955, the gaming system may determine if additional rounds of the game are available based on the round meter. As shown in FIG. 10B, the round meter 1005A reflects that additional rounds of the bonus game are available. Because additional rounds of the bonus game are available, the gaming system may return to block 905 to repeat the operation 900.

For example, as shown in FIG. 10C, the gaming system executed another round of the bonus game. In some implementations, the gaming system randomly determines additional symbols for the first set of reels 1002A-1002E and for the non-interacting reel 1002F. As illustrated, symbols that were not assigned credit awards in FIG. 10B were not held and were replaced with the new randomly determined symbols. Specifically, star symbols in symbol display area 1010D and 1010F were replaced with blank symbols. FIG. 10C also illustrates that the gaming system generated and displayed new star symbols in symbol display areas 1010B, 1010N, and 1010P, replacing the blank symbols in these symbol display areas. Blank symbols in other symbol display areas were randomly replaced with new blank symbols. The star symbols in symbol display areas 1010H, 1010J, 1010L, and 1010M were held from the prior round of the bonus game. In some implementations, the gaming system may generate new symbols in symbol display areas 1010H, 1010J, 1010L, and 1010M, where the new symbols are obscured by the existing symbols that were held. In some implementations, the gaming system does not generate new symbols for symbol display areas that display held symbols.

The gaming system also displayed new symbols for the non-interacting reel 1002F. Specifically, the gaming system randomly determined and displayed a 225 credit award symbol in symbol display area 1010Q, a +3 free round award symbol in symbol display area 1010R, and a MINOR jackpot awards symbol in symbol display area 1010T.

As previously discussed, the gaming system may evaluate the symbols on the non-interacting reel 1002F. If the gaming system determines that symbols are displayed in symbol display areas of the non-interacting reel 1002F, the gaming system may also determine if symbols are also displayed in associated reels 1002A-1002E. For example, the gaming system may determine if symbols are displayed in reel 1002A because reel 1002A is associated with symbol display area 1010Q, if symbols are displayed in reel 1002B because reel 1002B is associated with symbol display area 1010R, and if symbols are displayed in reel 1002D because reel 1002B is associated with symbol display area 1010T. It should be appreciated that in some implementations, the gaming system evaluates all reels for symbols that will interact, rather than selectively evaluating the reels for symbols.

The gaming system may assign awards to the displayed symbols for the first set of reels based on the interacting symbols displayed in the non-interacting reel in some implementations. As shown in FIG. 10D, the gaming system determined that symbols were not displayed in reel 1002A, thus the gaming system did not assign the 225 credit award to any symbol in reel 1002A. As also shown in FIG. 10D, the gaming system assigned a +3 free rounds award to the star symbol in symbol display area 1010B because of the association between the symbol display area 1010R and the reel 1002B and because the star symbol interacts with the interacting symbol. In some implementations, the free round awards (e.g., the +3 free rounds award) assigned to star symbols can be added to the round meter when assigned to the round meter. However, in alternative implementations, free rounds awards can be provided to the player and added to the round meter at other suitable time during the play of a round. In some implementations, where the gaming system determines that the player will obtain a free round award, the gaming system may directly provide the free round award to the player (e.g., automatically add the free round award to the round meter) without assigning the free round award to star symbol. It should also be appreciated that while the example implementations discussed herein disclose that certain symbols are held (e.g., the star symbol in 1010L that was already assigned a 25 credit award symbol), the gaming system may alternatively overwrite certain held symbols with other interacting symbols (e.g., when an interacting symbol is associated with a greater value than an award symbols that is currently held in a reel). For example, if the interacting symbol in symbol display area 1010R was a MAJOR jackpot interacting symbol, the gaming system may determine that the MAJOR jackpot interacting symbol would result in a star symbol in symbol display area 1010L being associated with a larger award than the currently displayed 25 credit award symbol. Thus, is some alternative implementations the gaming system may overwrite the 25 credit award star symbol with an interactive symbol that would improve the award associated with the currently held star symbol.

As also shown in FIG. 10D, the gaming system assigned a MINOR jackpot award to the star symbol in symbol display area 1010N because of the association between the symbol display area 1010T and the reel 1002D and because the star symbols interact with the interacting symbol. The gaming system did not assign an award to the symbol displayed in symbol display area 1010P because the gaming system did not generate and display an interacting symbol in 1010U of the non-interacting reel 1002F. The gaming system may determine which displayed symbols to hold and which displayed symbol can be replaced in a next round of the bonus game. In the example implementation of FIG. 10D, the gaming system may determine that star symbols with credit awards and jackpot awards (e.g., the star symbols in symbol display areas 1010H, 1010J, 1010L, 1010M, 1010N are held. The gaming system may also determine that the star symbol in symbol display area 1010B assigned a free round award will not be held because the type of award is not a credit award, the star symbol in symbol display area 1010P will not be held because no award was assigned to the star symbol, and the symbol display areas with blank symbols will not be held because star symbols with assigned awards were not displayed in these symbol display areas. The gaming system may issue awards to the displayed symbols with newly assigned awards of the first set of reels in this round of the bonus game and update the credit balance based on the one or more awards. The gaming system may determine if additional rounds of the game are available based on the round meter. In the illustrated implementation, the gaming system may also update the round meter 1005A to “4” due to the +3 free round award won in symbol display area 1010B. Thus, if additional rounds of the game are available, the gaming system may execute these rounds in a manner similar to the manner described above (not shown). In some implementations, the gaming system does not determine which symbols to hold and which symbols to replace in a particular round of the bonus game where additional rounds of the bonus game are not available.

In some implementations, if additional rounds of the bonus game are not available or the player decides to terminate the play of the game or play of the bonus game, operation 900 ends. In some such implementations, the player may continue the gaming session (e.g., play another consecutive play of the game) by executing another play of the game (e.g., part of a gaming session). That is, the player may place another wager and start a new play of the game (e.g., return to block 315 of FIG. 3A). However, continued game play is dependent on the number of credits remaining in the player's credit balance. The player may choose to cash out. The player may select an input button associated with a cash out request, where the processor of the gaming system may receive a cash out signal or request. In such an instance, the gaming system can provide the player a value based on the player's credit balance using any of the value items discussed above (bills, coins, vouchers, etc.).

In some implementations, the features described herein technologically improves the gaming system by performing selective evaluations of displayed symbols. For example, when evaluating the symbols displayed in the reels (e.g., reels 1002A-1002E) associated with the non-interacting reel in the hold and respin game, the gaming system may limit its evaluation of displayed symbols to reels (e.g., reels 1002A-1002E) that are associated with symbol display areas of a non-interacting reel that also display symbols, rather than evaluating all displayed symbols in the reels (e.g., reels 1002A-1002E). By minimizing the processor's evaluation of displayed symbols within the reels (e.g., reels 1002A-1002E), the gaming system reduces the quantity of symbols it evaluates, enabling the gaming systems to complete a play of a game more quickly than systems that evaluate all of the displayed symbols. By doing so, in some implementations, the disclosed gaming systems can increase the usage rate of the gaming system by allowing more games to be completed in a given time period (e.g., games per hour) and by reducing power consumed during one or more plays of a game.

Moreover, in some implementations, reducing the quantity of displayed symbols that are evaluated during the hold and respin game also reduces the processing load and memory consumption of the gaming system. By doing so, implementations of the disclosed gaming system avoid reading and writing certain symbols to and from memory, which increases the efficiency of the gaming system by conserving processor loading and reduces memory consumption. And, when such efficiency improvements are made and applied to the hundreds or thousands of game evaluations in multiple installations of the gaming system (e.g., multiple devices installed at a casino), implementations of the disclosed gaming system provide casino game operators sizable gains in machine efficiency, which is a technological improvement.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A gaming system comprising:
a display device, an input device, a value acceptor, a value dispenser, a random number generator, a memory device, and a processor, wherein the memory device stores program instructions that, when executed by the processor, cause the processor to:
establish a credit balance based on a value received by the value acceptor;
receive, via the input device, a wager for a play of a game using the credit balance;
determine, using the random number generator, a first plurality of symbols from a set of reels and a second plurality of symbols from a non-interacting reel, wherein the second plurality of symbols comprise at least one interacting symbol;
display, on the display device, the first plurality of symbols in a plurality of symbol display areas of the set of reels;
display, on the display device, the second plurality of symbols in a second plurality of symbol display areas of the non-interacting reel, wherein the second plurality of symbol display areas are different from the first plurality of symbol display areas;
assign an award to at least one of the first plurality of symbols based on the at least one interacting symbol of the second plurality of symbols;
issue the award assigned to the at least one of the first plurality of symbols; and
issue a second value from the value dispenser based on the award.

2. The gaming system of claim 1, wherein the at least one of the first plurality of symbols assigned an award is held for a next spin of the first set of reels.

3. The gaming system of claim 1, wherein a plurality of the first plurality of symbols are assigned awards and the plurality of the first plurality of symbols that are assigned awards are held for a next spin of the first set of reels.

4. The gaming system of claim 3, wherein a first one of the first plurality of symbols that is assigned the award is held for the next spin of the first set of reels and a second one of the first plurality of symbols that is assigned a second award is not held for the next spin of the first set of reels.

5. The gaming system of claim 4, wherein the award is different from the second award.

6. The gaming system of claim 4, wherein the award is a jackpot award and the second award is one or more free spins of the first set of reels.

7. The gaming system of claim 1, wherein the program instructions further cause the processor to replace at least one of the first plurality of symbols with another symbol from the first set of reels.

8. The gaming system of claim 1, wherein a symbol display area of the non-interacting reel is associated with a reel of the first set of reels.

9. The gaming system of claim 8, wherein assigning the award to the at least one of the first plurality of symbols further comprises assigning the award to at least one symbol in the reel that is associated with the symbol display area of the non-interacting reel displaying the interacting symbol.

10. The gaming system of claim 8, wherein assigning the award to the at least one of the first plurality of symbols further comprises assigning the award to a plurality of symbols in the reel that is associated with the symbol display area of the non-interacting reel displaying the interacting symbol.

11. The gaming system of claim 1, wherein the second plurality of symbols comprise at least two interacting symbols and wherein the program instructions cause the processor to further:
assign a first award to a first one of the first plurality of symbols based on a first one of the at least two interacting symbols;
assign a second award to a second one of the first plurality of symbols based on a second one of the at least two interacting symbols,
wherein the first award is a credit award and the second award is a free spin award.

12. The gaming system of claim 11, wherein the first one of the first plurality of symbol assigned the first award is held and the second one of the first plurality of symbols is replaced in a next round of the play of the game.

13. A method of operating a gaming system comprising:
establishing, by a processor, a credit balance based on a value received by the value acceptor;
receiving, by the processor from a player input device, a wager for a play of a game using the credit balance;
determining, using a random number generator, a first plurality of symbols from a set of reels and a second plurality of symbols from a non-interacting reel, wherein the second plurality of symbols comprise at least one interacting symbol;
displaying, on a display device, the first plurality of symbols in a plurality of symbol display areas of the set of reels;
displaying, on the display device, the second plurality of symbols in a second plurality of symbol display areas of the non-interacting reel, wherein the second plurality of symbol display areas are different from the first plurality of symbol display areas;
assigning, using the processor, an award to at least one of the first plurality of symbols based on the at least one interacting symbol of the second plurality of symbols;
issuing, using the processor, the award assigned to the at least one of the first plurality of symbols; and
issuing a second value from the value dispenser based on the award.

14. The method of claim 13, wherein the at least one of the first plurality of symbols assigned an award is held for a next spin of the first set of reels.

15. The method of claim 13, wherein a plurality of the first plurality of symbols are assigned awards and the plurality of the first plurality of symbols that are assigned awards are held for a next spin of the first set of reels.

16. The method of claim 15, wherein a first one of the first plurality of symbols that is assigned the award is held for the next spin of the first set of reels and a second one of the first plurality of symbols that is assigned a second award is not held for the next spin of the first set of reels.

17. The method of claim 16, wherein the award is different from the second award.

18. The method of claim 16, wherein the award is a jackpot award and the second award is one or more free spins of the first set of reels.

19. A non-transitory computer-readable storage device having program instructions stored therein, the program instructions being executable by a processor to cause a gaming system to:
establish, by the processor, a credit balance based on a value received by the value acceptor;
receive, by the processor from a player input device, a wager for a play of a game using the credit balance;
determine, using a random number generator, a first plurality of symbols from a set of reels and a second plurality of symbols from a non-interacting reel, wherein the second plurality of symbols comprise at least one interacting symbol;
display, on a display device, the first plurality of symbols in a plurality of symbol display areas of the set of reels;
display, on the display device, the second plurality of symbols in a second plurality of symbol display areas of the non-interacting reel, wherein the second plurality of symbol display areas are different from the first plurality of symbol display areas;
assign, using the processor, an award to at least one of the first plurality of symbols based on the at least one interacting symbol of the second plurality of symbols;
issue, using the processor, the award assigned to the at least one of the first plurality of symbols; and
issue a second value from the value dispenser based on the award.

20. The non-transitory computer-readable storage device of claim 19, wherein the second plurality of symbols comprise at least two interacting symbols and wherein the program instructions cause the processor to further:
assign a first award to a first one of the first plurality of symbols based on a first one of the at least two interacting symbols;
assign a second award to a second one of the first plurality of symbols based on a second one of the at least two interacting symbols,
wherein the first award is a credit award and the second award is a free spin award.
